(19) United States
(12) Patent Application Publication
(10) Pub. No.: US 2026/0075413 A1
(43) Pub. Date: Mar. 12, 2026

(54) ATTESTATION AND AUTHENTICATION FOR COMMUNICATION SESSIONS BETWEEN DEVICES

(71) Applicant: QUALCOMM Incorporated, San Diego, CA (US)

(72) Inventors: Justin CAUTHEN, Mallow (IE); Mehul SOMAN, San Jose, CA (US); Diyan TENG, Sunnyvale, CA (US); Nauman SHAHID, Cork (IE); Rashmi KULKARNI, Redwood City, CA (US); Nisarg Keyurbhai TRIVEDI, Santa Clara, CA (US)

(21) Appl. No.: 18/882,545

(22) Filed: Sep. 11, 2024

(51) Int. Cl. H04W 12/06

(52) U.S. Cl. CPC H04W 12/06

(57) ABSTRACT

Systems and techniques are provided for wireless communications. A first device can receive a request to initiate a communication session between a second device and the first device, the request including caller attestation information corresponding to a user of the second device and determined by the second device based on information obtained from one or more sensors included in the second device. An authentication result corresponding to the request to initiate the communication session can be determined, based on comparing the caller attestation information included in the request with authentication configuration information associated with a user of the first device. The communication session between the second device and the first device can be configured based on the authentication result, by processing one or more inputs corresponding to biometric information of the user of the first device based on the authentication result.

### FIELD

Aspects of the present disclosure generally relate to wireless communication. In some implementations, examples are described for interactive communication sessions using call initiation requests with attestation information and using biometric data sharing configurations associated with a recipient of the call initiation request.

### BACKGROUND

Wireless communications systems are deployed to provide various telecommunication services, including telephony, video, data, messaging, broadcasts, among others. Wireless communications systems have developed through various generations, including a first-generation analog wireless phone service (1G), a second-generation (2G) digital wireless phone service (including interim 2.5G networks), a third-generation (3G) high speed data, Internet-capable wireless service, a fourth-generation (4G) service (e.g., Long-Term Evolution (LTE), WiMax), and a fifth-generation (5G) service (e.g., New Radio (NR)). There are presently many different types of wireless communications systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile communication (GSM), etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for performing wireless communication. According to at least one illustrative example, a method for wireless communication is provided, the method including: receiving, from a second device, a request to initiate a communication session between the second device and the first device wherein the request includes caller attestation information corresponding to a user of the second device, the caller attestation information determined by the second device based on information obtained from one or more sensors included in the second device; determining an authentication result corresponding to the request to initiate the communication session, the authentication result determined based on comparing the caller attestation information included in the request with authentication configuration information associated with a user of the first device; and configuring the communication session between the second device and the first device based on the authentication result, wherein configuring the communication session includes processing one or more inputs corresponding to biometric information of the user of the first device based on the authentication result.

In another example, an apparatus for wireless communication is provided. The apparatus includes at least one memory and at least one processor coupled to the at least one memory. The at least one processor is configured to: receive, from a second device, a request to initiate a communication session between the second device and the first device wherein the request includes caller attestation information corresponding to a user of the second device, the caller attestation information determined by the second device based on information obtained from one or more sensors included in the second device; determine an authentication result corresponding to the request to initiate the communication session, the authentication result determined based on comparing the caller attestation information included in the request with authentication configuration information associated with a user of the first device; and configure the communication session between the second device and the first device based on the authentication result, wherein configuring the communication session includes processing one or more inputs corresponding to biometric information of the user of the first device based on the authentication result.

In another example, a non-transitory computer-readable storage medium is provided, comprising instructions stored thereon which, when executed by at least one processor, causes the at least one processor to: receive, from a second device, a request to initiate a communication session between the second device and the first device wherein the request includes caller attestation information corresponding to a user of the second device, the caller attestation information determined by the second device based on information obtained from one or more sensors included in the second device; determine an authentication result corresponding to the request to initiate the communication session, the authentication result determined based on comparing the caller attestation information included in the request with authentication configuration information associated with a user of the first device; and configure the communication session between the second device and the first device based on the authentication result, wherein configuring the communication session includes processing one or more inputs corresponding to biometric information of the user of the first device based on the authentication result.

In another example, an apparatus is provided for wireless communication. The apparatus includes: means for receiving, from a second device, a request to initiate a communication session between the second device and the first device wherein the request includes caller attestation information corresponding to a user of the second device, the caller attestation information determined by the second device based on information obtained from one or more sensors included in the second device; means for determining an authentication result corresponding to the request to initiate the communication session, the authentication result determined based on comparing the caller attestation information included in the request with authentication configuration information associated with a user of the first device; and means for configuring the communication session between the second device and the first device based on the authentication result, wherein configuring the communication session includes processing one or more inputs corresponding to biometric information of the user of the first device based on the authentication result.

In another illustrative example, a method for wireless communication is provided, the method including: obtaining one or more inputs corresponding to a user of a first device, wherein the one or more inputs comprise sensor data obtained from one or more sensors of the first device; generating caller attestation information based on the sensor data of the one or more inputs, wherein the caller attestation information is indicative of one or more detected attestation features corresponding to the user of the first device and represented within the sensor data, and wherein the one or more detected attestation features are included in a configured plurality of attestation features; transmitting, to a second device, a request to initiate a communication session between the first device and the second device, wherein the request includes the caller attestation information; and receiving, from the second device and during the communication session, biometric information of a user of the second device, wherein the biometric information is received based on a successful authentication of the caller attestation information by the second device.

In another example, an apparatus for wireless communication is provided. The apparatus includes at least one memory and at least one processor coupled to the at least one memory. The at least one processor is configured to: obtain one or more inputs corresponding to a user of a first device, wherein the one or more inputs comprise sensor data obtained from one or more sensors of the first device; generate caller attestation information based on the sensor data of the one or more inputs, wherein the caller attestation information is indicative of one or more detected attestation features corresponding to the user of the first device and represented within the sensor data, and wherein the one or more detected attestation features are included in a configured plurality of attestation features; transmit, to a second device, a request to initiate a communication session between the first device and the second device, wherein the request includes the caller attestation information; and receive, from the second device and during the communication session, biometric information of a user of the second device, wherein the biometric information is received based on a successful authentication of the caller attestation information by the second device.

In another example, a non-transitory computer-readable storage medium is provided, comprising instructions stored thereon which, when executed by at least one processor, causes the at least one processor to: obtain one or more inputs corresponding to a user of a first device, wherein the one or more inputs comprise sensor data obtained from one or more sensors of the first device; generate caller attestation information based on the sensor data of the one or more inputs, wherein the caller attestation information is indicative of one or more detected attestation features corresponding to the user of the first device and represented within the sensor data, and wherein the one or more detected attestation features are included in a configured plurality of attestation features; transmit, to a second device, a request to initiate a communication session between the first device and the second device, wherein the request includes the caller attestation information; and receive, from the second device and during the communication session, biometric information of a user of the second device, wherein the biometric information is received based on a successful authentication of the caller attestation information by the second device.

In another example, an apparatus is provided for wireless communication. The apparatus includes: means for obtaining one or more inputs corresponding to a user of a first device, wherein the one or more inputs comprise sensor data obtained from one or more sensors of the first device; means for generating caller attestation information based on the sensor data of the one or more inputs, wherein the caller attestation information is indicative of one or more detected attestation features corresponding to the user of the first device and represented within the sensor data, and wherein the one or more detected attestation features are included in a configured plurality of attestation features; means for transmitting, to a second device, a request to initiate a communication session between the first device and the second device, wherein the request includes the caller attestation information; and means for receiving, from the second device and during the communication session, biometric information of a user of the second device, wherein the biometric information is received based on a successful authentication of the caller attestation information by the second device.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof.

FIG. 1A illustrates an example implementation of a system-on-a-chip (SOC), in accordance with some examples;

FIG. 1B is a block diagram illustrating components of a user computing device, in accordance with some examples;

FIG. 2 is a call flow diagram illustrating an example of an interactive communication session request and establishment between a first device and a second device, in accordance with some examples;

FIG. 3 is a diagram illustrating an example of a first and second configuration for sharing of user biometric data to an interactive communication session based on detecting or not detecting a user intent to communicate, in accordance with some examples;

FIG. 4 is a signaling diagram illustrating an example of unsuccessful authentication of a call initiation request based on attestation information of the call initiator and performing the call session with a user biometric data sharing configuration based on the unsuccessful authentication result, in accordance with some examples;

FIG. 5 is a signaling diagram illustrating an example of successful authentication of a call initiation request based on attestation information of the call initiator and performing the call session with a user biometric data sharing configuration based on the successful authentication result, in accordance with some examples;

FIG. 6 is a diagram illustrating an example of an attestation bitmask that can be included as attestation information of an interactive communication session or call initiation request, in accordance with some examples;

FIG. 7 is a diagram illustrating an example of determining an authentication result based on a comparison between an attestation bitmask of a calling party and a safety profile or authentication requirements configuration of a receiving party, in accordance with some examples;

FIG. 8 is a diagram illustrating another example of determining a successful authentication result based on a comparison between an attestation bitmask of a calling party and a safety profile or authentication requirements configuration of a receiving party, in accordance with some examples;

FIG. 9 is a diagram illustrating another example of determining an unsuccessful authentication result based on a comparison between an attestation bitmask of a calling party and a safety profile or authentication requirements configuration of a receiving party, in accordance with some examples;

FIG. 10 is a diagram illustrating another example of determining a successful authentication result based on a comparison between an attestation bitmask of a calling party and a safety profile or authentication requirements configuration of a receiving party, in accordance with some examples;

FIG. 11 is a flow diagram illustrating an example of a process for authentication and/or attestation of communications between user devices, in accordance with some examples;

FIG. 12 is a flow diagram illustrating another example of a process for authentication and/or attestation of communications between user devices, in accordance with some examples; and

FIG. 13 is a block diagram illustrating an example of a computing system, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Wireless communication networks can be deployed to provide various communication services, such as voice, video, packet data, messaging, broadcast, any combination thereof, or other communication services. Wireless communication networks can be used by various wireless communication systems, platforms, services, etc., to provide a communication session between two or more users. For example, a communication session may be an interactive communication session between at least a first user device and a second user device. An interactive communication session can be a communication session that includes bidirectional communications (e.g., communications from the first user device to the second user device, and communications from the second user device to the first user device). In some examples, an interactive communication session can include voice calls, video calls, data calls or data sessions, packet-switched calls, circuit-switched calls, etc., among various other communications between a first user associated with a first user device and at least one additional user associated with an additional user device. For example, an interactive communication session may also include communications between users (e.g., and corresponding user devices) within a virtual reality (VR), augmented reality (AR), and/or mixed reality (MR) environment, etc. As used herein, a “communication session” or “interactive communication session” may be interchangeably referred to as a “call.”

Various communication systems may be configured to implement secure communications between the participating user devices or other communications unit, for example using various processes of pairing and authentication between the participating devices. Many wireless technologies implement cryptographic key exchange mechanisms to provide the participating communications units with exchanged and shared secret information that can be used to confirm (e.g., authenticate) the identity of one or more participating parties in a call or other communication session between the participating communications units. In some cases, authentication of one or more participating parties in a call may be provided by one or more third-party (e.g., external) servers, services, systems, etc., that are not participants in the call or communication session. For example, various external authentication servers and services may be used to provide authentication of a calling party identity (e.g., the identity of the user of the device transmitting a call initiation request) and/or of a calling party device (e.g., the user device or communications unit used by the calling party to transmit the call initiation request, etc.).

In some cases, secure communications techniques may be designed to prevent, or reduce the likelihood of occurrence of, various vulnerabilities and attacks that may be associated with calls or other communication sessions between users. For example, man-in-the middle attacks (MITM) may be performed by an attacker intercepting the communications between legitimate parties, potentially eavesdropping and/or altering the content of the communications. In another example, identity spoofing may be performed by an attacker impersonating legitimate users or entities to deceive a called party into accepting a call initiation request that purports to be from the legitimate user or entity rather than the attacker. Various other types of attacks may include voice phishing attacks (e.g., social engineering attacks using deceptive calls to trick victims into revealing sensitive information), registration hijacking, caller ID spoofing, signal protocol tampering, etc.

In another example, identity theft attacks may be performed to target the unauthorized capture (e.g., theft) of a called user's biometric data, such as data or information related to the called user's voice, appearance, gestures, movement patterns, etc. In some cases, the attacker associated with an identity theft attack is the calling party (e.g., the call initiator), and the victim associated with an identity theft attack is the called party (e.g., the call recipient). In some cases, captured biometric information can be obtained (e.g., by the attacker) from the called user in an identity theft attack, and the captured biometric information may subsequently be used to impersonate the victim. For example, the stolen biometric information of the called user may be used to bypass one or more biometric authentications or biometric verifications that have been configured to provide access control and/or account security for an account specific to the called user (e.g., the victim of the identity theft attack) on various other devices, platforms, systems, etc. In some cases, after using the stolen biometric information to gain access to the victim's devices and/or online accounts, the attacker may access private or sensitive information stored on the user's devices and/or online accounts. In other examples, the attacker may use the stolen biometric information to impersonate the victim without the knowledge and/or consent of the victim.

In some cases, identity theft attacks can be performed based on an attacker initiating a fake and/or scripted (e.g., automated, such as by using one or more computer code scripts, etc.) video call to the victim. The identity theft video call can be performed using various communications systems, platforms, protocols, etc. The attacker may initiate the identity theft attack based on transmitting a call initiation request to the user device of the victim. In some cases, the identity theft attack may be performed based on the victim (e.g., the called party) accidentally or inadvertently accepting the incoming call initiation request from the attacker. Accepting the incoming call initiation request may cause the victim's user device to immediately begin streaming and/or sharing audio data, video data, and/or other data that includes or is indicative of biometric information of the victim.

In some examples, an incoming call initiation request from an attacker performing the identity theft attack may cause the victim's device to leak or unintentionally share or reveal biometric information of the call recipient (e.g., the victim) during the call initiation and setup stages. For instance, the victim's device that receives the incoming call initiation request from the identity theft attacker may instantly activate one or more camera(s), microphone(s), and/or other sensors that obtain biometric information of the victim, where the activation is performed in response to receiving the attacker's call initiation request. In some cases, the cameras or other sensors on the device that capture biometric information of the user may be turned on as an immediate response to the victim device receiving the attacker's call initiation request and/or may be turned on as a first step in a call setup and establishment procedure performed by the victim device, etc.

Based on the attacker initiating (e.g., transmitting) the fake call initiation request to the victim, the always-on or instant biometric sensor activation behavior of many video calling platforms, systems, applications, etc., can be exploited by the attacker to steal, and later misuse, biometric information of the recipient of the fake call initiation request (e.g., victim). In some cases, identity theft attacks may also be referred to as “fake call attacks,” where the attacker is the initiator of the fake call and the target or victim of the attack is the recipient of the fake call. As used herein, the attacker and/or the user device associated with the attacker and used to transmit the call initiation request may also be referred to, individually or in combination, as the “initiator,” the “call initiator,” the “initiating party,” the “calling party,” and/or the “caller.” As used herein, the target or victim of the attack (and/or the user device thereof) may also be referred to, individually or in combination, as the “recipient,” the “call recipient,” the “receiving party,” the “called party,” and/or the “receiver.”

In some examples, identity theft attacks that target and steal unintentionally leaked biometric information of the victim may be performed for various types of communication sessions or interactive sessions where user biometric information and/or data indicative of the user biometric information is captured and/or transmitted by a user device in response to receiving a call initiation request from the attacker. For example, as noted above, the various types of interactive communication sessions where identity theft attacks may be performed often involve the capture and/or transmission of user biometric information, and/or indications thereof, based on an expectation or assumption that the calling party on the other end of an incoming request for an interactive communication session is legitimate (e.g., is not an attacker).

The interactive communication sessions that may be targeted by identity theft attacks to steal leaked or unintentionally streamed biometric information of a victim can use various different communication modalities, and various different sensors on the victim device may perform the capture of the biometric information that is leaked or stolen during the identity theft attack. For example, video calls can leak biometric information relating to the user's voice (e.g., captured by one or more microphones of the victim's device), the user's appearance (e.g., captured by one or more cameras of the victim's device), etc. In another example, voice calls can leak biometric information relating to the user's voice, but do not usually leak biometric information relating to the user's appearance, etc.

In some cases, video calls and/or other types of interactive communication sessions can leak biometric information relating to the user's movements, gait, gestures, etc., when the captured image or video data obtained for the video call includes one or more respective representations or indications of the user's movements, gait, gestures, etc. In another example, virtual reality (VR), extended reality (XR), mixed reality (MR), and/or augmented reality (AR) systems can be used for interactive communication sessions between users where biometric information may be inadvertently or unintentionally shared, for example during an identity theft attack. In some cases, an expected behavior for such platforms may be to capture biometric information of the user, and use the captured biometric information to render a corresponding avatar of the user within the VR, AR, etc., environment. In some cases, an identity theft attack may correspond to an attacker obtaining movement-related information of a victim user. In another example relating to XR use cases, an attacker may attempt to gain access to a victim user's point-of-view (POV) in camera-based passthrough-capable devices, may attempt to gain access to an XR headset's microphone(s) and/or cameras, etc.

Identity theft attacks may be performed by an attacker initiating a call or other interactive communication session with the victim user. There is a need for systems and techniques to provide authentication, verification, and/or attestation that can be used to confirm that the initiator of an incoming call or communication session request is legitimate before streaming biometric information and/or sensor data captured by the call recipient user device(s). There is a further need for systems and techniques that can be used to implement attestation information for authenticating the initiator associated with a request or initiation action corresponding to an interactive session with a recipient, where biometric information and/or sensor data of the recipient is not streamed unless the initiator is authenticated based on the attestation information provided by the initiator during the request for the interactive session with the recipient.

Systems, apparatuses, processes (also referred to as methods), and computer-readable media (collectively referred to as “systems and techniques”) are described herein that can be used to provide authentication, verification, and/or attestation of an initiator of an incoming call or communication session request received by a user device. For example, the systems and techniques can be used to authenticate the identity of the initiator associated with an incoming call or communication session request, where the initiator is associated with a second user device used to transmit the call or communication session request. In some examples, authenticating the identity of the initiator can be based on authenticating that the initiator is a legitimate human user initiating the incoming call or communication session request. In some examples, the authentication for the initiator can be implemented based on caller attestation information corresponding to the initiator (e.g., corresponding to the user of the second device). In one illustrative example, the caller attestation information can be included in a call initiation request and/or a communication session initiation request transmitted by the second device and received by the user device.

The caller attestation information can comprise an attestation bitmask included within the request to initiate the communication session. For example, the caller attestation information and/or attestation bitmask may be appended to the request. In some cases, the caller attestation information and/or attestation bitmask can be included in a payload or data field of the request to initiate the communication session. The caller attestation information can be generated and/or determined by the user device associated with the call initiator. For example, the caller attestation information can be obtained without communications to an external computing system or computing device, and without communications to an additional computing system or computing device.

In some examples, the caller attestation information can include one or more attestation features generated or determined by the call initiator device. The attestation features can correspond to a gesture, movement, action, etc., performed by the call initiator and detected in sensor data obtained from one or more sensors of the call initiator device. In some examples, the attestation features can correspond to a spoken keyword uttered by the call initiator, and/or can correspond to biometric data of the call initiator provided to one or more biometric sensors included in the call initiator device. The one or more attestation features can be generated before and/or during the transmission of the request to initiate the communication session by the call initiator device. In some cases, the caller attestation information can include a combination of attestation features that were generated or determined before the request to initiate the communication session, and one or more attestation features that were generated or determined during (e.g., concurrently with) the generating and transmitting of the request to initiate the communication session by the call initiator device.

In one illustrative example, the caller attestation information included in the request to initiate the communication session can be implemented using an attestation bitmask. The attestation bitmask can include a plurality of attestation bits, where each attestation bit corresponds to a respective attestation feature included in a plurality of configured attestation features used for authentication of the initiating party associated with a request to initiate a communication session. An attestation bit having a first value (e.g., a value of ‘0’) can indicate that the corresponding attestation feature was not detected by the call initiator device prior to and/or during the generating of the request to initiate the communication session. A second value (e.g., a value of ‘1’) can be set for the attestation bit to indicate that the corresponding attestation feature was detected by the call initiator device prior to and/or during the generation of the request to initiate the communication session.

In some cases, the plurality of attestation bits included in the attestation information can be indicative of (e.g., can attest to) the presence of one or more gestures or features performed by the user of the call initiator device, in association with transmitting the request to initiate the communication session. The one or more gesture or features performed by the user of the call initiator device can comprise respective attestation features used for authentication by the recipient of the request to initiate the communication session. In some aspects, the presence of attestation information or attestation bits indicating that a corresponding set of attestation features were detected for a user of the call initiator device can indicate that the incoming request to initiate the communication session at the call recipient device corresponds to a legitimate human user initiating the call. For example, the presence of attestation information or attestation bits may indicate the incoming request is from a legitimate human caller, and is not a call request initiated by an automated script or other automated dialing system, etc. In some aspects, the gestures or features that may be signaled by the attestation information indicative of a real user initiating the call can include one or more of detection of a pickup gesture performed by the initiating party at the time of call initiation, facial recognition of the initiating party at or during the call initiation, voice recognition of the initiating party at or during the call initiation, keyword detection, motion or movement detection and/or motion pattern or movement pattern detection, etc.

In some examples, the call recipient device can use the attestation bitmask or other caller attestation information included in the request to initiate the communication session to determine an authentication result for the incoming request. For example, the call recipient device can compare the attestation bitmask or other caller attestation information with one or more authentication requirements included in authentication configuration information associated with a user of the call recipient device. In some examples, the authentication configuration information may be indicative of one or more user preferences corresponding to a level of authentication needed for a successful authentication result to be determined. For example, the authentication configuration information can indicate a minimum number of authentication features that must be present within (e.g., included within and/or indicated by) the received caller attestation information included in the request. An incoming request with fewer than the configured minimum number of authentication features can correspond to a determination of an unsuccessful authentication result. An incoming request with greater than or equal to the configured minimum number of authentication features can correspond to a determination of a successful authentication result.

In some examples, the authentication configuration information can indicate a subset of attestation features of the plurality of configured attestation features, where the subset of attestation features represent required attestation features for determining a successful authentication result. For example, an attestation bitmask that indicates one or more of the required attestation features was not detected by the call initiator device can cause the call recipient device to determine an unsuccessful authentication result.

In some examples, the systems and techniques can be configured to generate obfuscated audio data and/or obfuscated image data to mask or remove biometric information of the user of the call recipient device, based on a determination of an unsuccessful authentication result for the caller attestation information of an incoming request to initiate a communication session with the call recipient device. For example, the audio and/or image data obtained by one or more sensors of the call recipient device can be processed with a quality reduction codec prior to being output for transmission to the call initiator device during the communication session, based on the determination of the unsuccessful authentication result. In some examples, the quality reduction codec can be configured to reduce or degrade an original resolution associated with the audiovisual inputs and biometric information of the user of the call recipient device. In some cases, the quality reduction codec can be configured to reduce or degrade an original sampling rate associated with the audiovisual inputs and biometric information of the user of the call recipient device. In another example, the quality reduction codec can be configured to blur (e.g., applying blurring) or mask (e.g., occlude or apply occluding to) the face of the user of the call recipient device in one or more frames of image data (e.g., including a plurality of frames of image data comprising a video) that are captured by the call recipient device for transmission to the communication session with the call initiator device.

Further aspects of the systems and techniques will be described with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), aircraft (e.g., an airplane, jet, unmanned aerial vehicle (UAV) or drone, helicopter, airship, glider, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.), and so on.

A network entity can be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (e.g., a network of spatially separated antennas connected to a common source via a transport medium) or a remote radio head (RRH) (e.g., a remote base station connected to a serving base station). Alternatively, the non-co-located physical TRPs may be the serving base station receiving the measurement report from the UE and a neighbor base station whose reference radio frequency (RF) signals (e.g., or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal”refers to a wireless signal or an RF signal.

Various aspects of the systems and techniques described herein will be discussed below with respect to the figures.

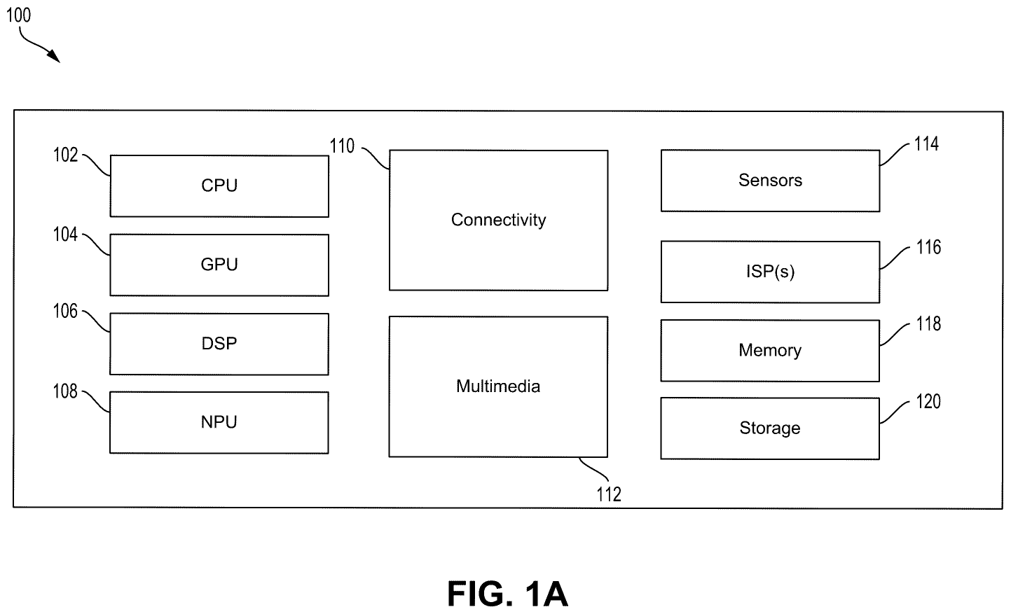

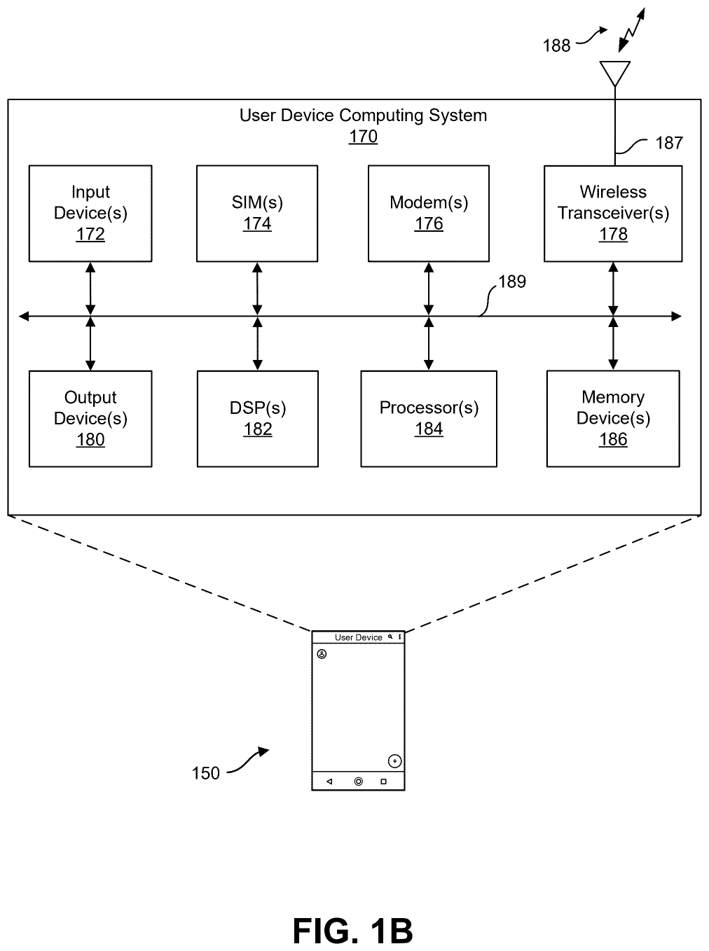

FIG. 1A illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In some implementations, the NPU is implemented in the CPU 102, DSP 106, and/or GPU 104. The SOC 100 may also include a sensor processor 114, image signal processors (ISPs) 116, and/or storage 120.

The SOC 100 may be based on an ARM instruction set. In an aspect of the present disclosure, the instructions loaded into the CPU 102 may comprise code to search for a stored multiplication result in a lookup table (LUT) corresponding to a multiplication product of an input value and a filter weight. The instructions loaded into the CPU 102 may also comprise code to disable a multiplier during a multiplication operation of the multiplication product when a lookup table hit of the multiplication product is detected. In addition, the instructions loaded into the CPU 102 may comprise code to store a computed multiplication product of the input value and the filter weight when a lookup table miss of the multiplication product is detected.

SOC 100 can be part of a computing device or multiple computing devices. In some examples, SOC 100 can be part of an electronic device (or devices) such as a camera system (e.g., a digital camera, an IP camera, a video camera, a security camera, etc.), a telephone system (e.g., a smartphone, a cellular telephone, a conferencing system, etc.), a desktop computer, an XR device (e.g., a head-mounted display, etc.), a smart wearable device (e.g., a smart watch, smart glasses, etc.), a laptop or notebook computer, a tablet computer, a set-top box, a television, a display device, a system-on-chip (SoC), a digital media player, a gaming console, a video streaming device, a server, a drone, a computer in a car, an Internet-of-Things (IoT) device, or any other suitable electronic device(s).

In some implementations, the CPU 102, the GPU 104, the DSP 106, the NPU 108, the connectivity block 110, the multimedia processor 112, the one or more sensors 114, the ISPs 116, the memory block 118 and/or the storage 120 can be part of the same computing device. For example, in some cases, the CPU 102, the GPU 104, the DSP 106, the NPU 108, the connectivity block 110, the multimedia processor 112, the one or more sensors 114, the ISPs 116, the memory block 118 and/or the storage 120 can be integrated into a smartphone, laptop, tablet computer, smart wearable device, video gaming system, server, and/or any other computing device. In other implementations, the CPU 102, the GPU 104, the DSP 106, the NPU 108, the connectivity block 110, the multimedia processor 112, the one or more sensors 114, the ISPs 116, the memory block 118 and/or the storage 120 can be part of two or more separate computing devices.

FIG. 1B illustrates an example of a computing system 170 of a wireless device 150. The wireless device 150 may include a client device such as a user equipment (UE) or other type of device (e.g., a station (STA) configured to communication using a Wi-Fi interface) that may be used by an end-user. For example, the wireless device 150 may include a mobile phone, router, tablet computer, laptop computer, tracking device, wearable device (e.g., a smart watch, glasses, an extended reality (XR) device such as a virtual reality (VR), augmented reality (AR), or mixed reality (MR) device, etc.), Internet of Things (IoT) device, a vehicle, an aircraft, and/or another device that is configured to communicate over a wireless communications network. The computing system 170 includes software and hardware components that may be electrically or communicatively coupled via a bus 189 (e.g., or may otherwise be in communication, as appropriate). For example, the computing system 170 includes one or more processors 184. The one or more processors 184 may include one or more CPUs, application specific integrated circuits (ASICs), field programmable gate arrays (FPGAs), GPUs, vision processing units (VPUs), neural signal processors (NSPs), microcontrollers, dedicated hardware, any combination thereof, and/or other processing device or system. The bus 189 may be used by the one or more processors 184 to communicate between cores and/or with one or more memory devices 186.

The computing system 170 may also include the one or more memory devices 186, one or more digital signal processors (DSPs) 182, one or more subscriber identity modules (SIMs) 174, one or more modems 176, one or more wireless transceivers 178, an antenna 187, one or more input devices 172 (e.g., a camera, a mouse, a keyboard, a touch sensitive screen, a touch pad, a keypad, a microphone, and/or the like), and one or more output devices 180 (e.g., a display, a speaker, a printer, and/or the like).

In some aspects, computing system 170 may include one or more radio frequency (RF) interfaces configured to transmit and/or receive RF signals. In some examples, an RF interface may include components such as modem(s) 176, wireless transceiver(s) 178, and/or antennas 187. The one or more wireless transceivers 178 may transmit and receive wireless signals (e.g., signal 188) via antenna 187 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the computing system 170 may include multiple antennas or an antenna array that may facilitate simultaneous transmit and receive functionality. Antenna 187 may be an omnidirectional antenna such that radio frequency (RF) signals may be received from and transmitted in all directions. The wireless signal 188 may be transmitted via a wireless network. The wireless network may be any wireless network, such as a cellular or telecommunications network (e.g., 3G, 1G, 5G, etc.), wireless local area network (e.g., a Wi-Fi network), a Bluetooth™ network, and/or other network.

In some examples, the wireless signal 188 may be transmitted directly to other wireless devices using sidelink communications (e.g., using a PC5 interface, using a dedicated short range communication (DSRC) interface, etc.). Wireless transceivers 178 may be configured to transmit RF signals for performing sidelink communications via antenna 187 in accordance with one or more transmit power parameters that may be associated with one or more regulation modes. Wireless transceivers 178 may also be configured to receive sidelink communication signals having different signal parameters from other wireless devices.

In some examples, the one or more wireless transceivers 178 may include an RF front end including one or more components, such as an amplifier, a mixer (e.g., also referred to as a signal multiplier) for signal down conversion, a frequency synthesizer (e.g., also referred to as an oscillator) that provides signals to the mixer, a baseband filter, an analog-to-digital converter (ADC), one or more power amplifiers, among other components. The RF front-end may generally handle selection and conversion of the wireless signals 188 into a baseband or intermediate frequency and may convert the RF signals to the digital domain.

In some cases, the computing system 170 may include a coding-decoding device (or CODEC) configured to encode and/or decode data transmitted and/or received using the one or more wireless transceivers 178. In some cases, the computing system 170 may include an encryption-decryption device or component configured to encrypt and/or decrypt data (e.g., according to the Advanced Encryption Standard (AES) and/or Data Encryption Standard (DES) standard) transmitted and/or received by the one or more wireless transceivers 178.

The one or more SIMs 174 may each securely store an international mobile subscriber identity (IMSI) number and related key assigned to the user of the wireless device 150. The IMSI and key may be used to identify and authenticate the subscriber when accessing a network provided by a network service provider or operator associated with the one or more SIMs 174. The one or more modems 176 may modulate one or more signals to encode information for transmission using the one or more wireless transceivers 178. The one or more modems 176 may also demodulate signals received by the one or more wireless transceivers 178 in order to decode the transmitted information. In some examples, the one or more modems 176 may include a Wi-Fi modem, a 1G (or LTE) modem, a 5G (or NR) modem, and/or other types of modems. The one or more modems 176 and the one or more wireless transceivers 178 may be used for communicating data for the one or more SIMs 174.

The computing system 170 may also include (and/or be in communication with) one or more non-transitory machine-readable storage media or storage devices (e.g., one or more memory devices 186), which may include, without limitation, local and/or network accessible storage, a disk drive, a drive array, an optical storage device, a solid-state storage device such as a RAM and/or a ROM, which may be programmable, flash-updateable, and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 186 and executed by the one or more processor(s) 184 and/or the one or more DSPs 182. The computing system 170 may also include software elements (e.g., located within the one or more memory devices 186), including, for example, an operating system, device drivers, executable libraries, and/or other code, such as one or more application programs, which may comprise computer programs implementing the functions provided by various aspects, and/or may be designed to implement methods and/or configure systems, as described herein.

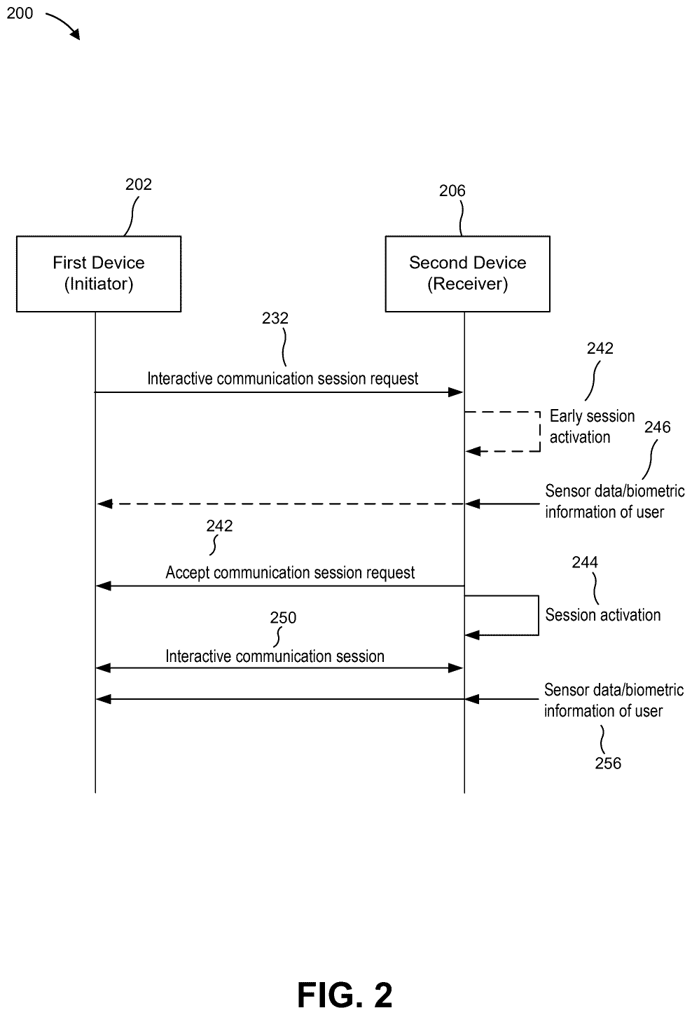

FIG. 2 is a call flow diagram illustrating an example of an interactive communication session 200 between a first device 202 and a second device 206, in accordance with some examples. In some examples, the first device 202 can be a user device associated with initiating a call or other interactive communication session, and may for example be referred to as the “initiator,” the “call initiator,” the “initiating party,” the “calling party,” and/or the “caller,” etc. The second device 206 can be a user device that receives the call initiation request or other interactive communication session request from the first device 202. The second device 206 may also be referred to as the “receiver,” the “recipient,”the “call recipient,”the “receiving party,”and/or the “called party,”etc.

The first device 202 can transmit a request 232 to the second device 206, where the request 232 is a request from the first device 202 to initiate an interactive communication session with the second device 206 (e.g., an interactive communication session between the initiator device 202 and the receiver device 206, and the respective users thereof). The request 232 may be a call request message generated and transmitted by the first device 202 according to various communication protocols and/or communication session protocols, systems, etc., that are used to provide the interactive communication session between the first device 202 and the second device 206. In some cases, the call request message 232 may include data to identify the calling device (e.g., first device 202) and the called device (e.g., second device 206). For example, the call request message 232 can include identifiers associated with the first device 202 and/or associated with a user of the first device 202. In some cases, the call request message 232 transmitted from the first device 202 to the second device 206 can include one or more data or payload fields, which can be configured to carry a plurality of bits indicative of data contents or payload contents of the call request message 232.

Based on receiving the call request message 232 at a first time, the second device 206 can be configured to generate and transmit at a later, second time, a message 242 indicative of acceptance of the communication session request 232. In some case, the call acceptance message 242 can be transmitted by the second device 206 in response to one or more user inputs received by the second device 206 from a user of the second device 206, where the one or more user inputs are configured to cause the second device 206 to accept the call request 232 from the first device 202. In some aspects, the call request message 232 and the call acceptance message 242 can be transmitted over various communications networks, including wired and/or wireless communication networks connected on a path between the first device 202 and the second device 206. The call request message 232 and the call acceptance message 242 can be transmitted (e.g., by the first device 202 and the second device 206, respectively) over the same network(s) or different network(s).

Based on transmitting the call acceptance message 242 at the second time, the second device 206 can be configured to perform session activation 244, where the session activation 244 includes call setup and/or call establishment at the second device 206 and/or with the first device 202. In some cases, the session activation 244 can cause the second device 206 to configure one or more sensors and/or user input devices included within or coupled to the second device 206 for capturing inputs from the user of the second device 206 that will be transmitted to the first device 202 during (e.g., within, etc.) the interactive communication session 250. For example, the interactive communication session 250 can be established and performed between the first device 202 and the second device 206 after completion of the session activation 244 at the second device 206. During the interactive communication session 250, the second device 206 can use one or more sensors and/or user input devices to capture sensor data and/or biometric information 256 corresponding to the user of the second device 206, where the captured sensor data and or information representative of the biometric information 256 is transmitted to the first device 202 during and in association with the ongoing interactive communication session 250 between the first device 202 and the second device 206.

In some cases, the second device 206 may perform early session activation 242 at a time between the first time (e.g., when the second device 206 receives the incoming call initiation request 232 transmitted by the first device 202) and the second time (e.g., when the second device 206 transmits the call acceptance message 242). In some cases, the early session activation 242 by the second device 206 may correspond to the second device 206 performing call setup, establishment, and/or activation prior to receiving the user input indicating acceptance of the call requests 232 by the user of the second device 206.

The early session activation 242 can, in some cases, cause the second device 206 to activate one or more sensors and/or user input devices in anticipation of using the one or more sensors and/or user input devices to capture audiovisual data of the user for transmission during the interactive communication session 250. For example, the early session activation 242 can correspond to the second device 206 powering on, waking, and/or activating one or more microphones to begin capturing audio data by the second device 206, where the captured audio data can include biometric information of the user of the second device 206 based on the captured audio data including a representation of the voice of the user. In another example, the early session activation 242 can correspond to the second device 206 powering on, waking, and/or activating one or more cameras or image capture devices to begin capturing image data and/or video data (e.g., a plurality of image data frames, a sequence of image data frames comprising a video, etc.) of the user of the second device 206. The captured image data may include biometric information of the user of the second device 206, based on the captured image data including representations of the face or other anatomy, bodily parts, and/or visual biometric features and information of the user.

In examples where early session activation 242 is performed or occurs at the second device 206, and where the early session activation 242 causes or corresponds to beginning the collection of sensor data or other biometric user information 246 prior to the start of the interactive communication session 250, the second device 206 may leak the biometric user information 246 by transmitting or streaming the collected data 246 to the first device 202 prior to the start of the interactive communication session 250.

As noted previously, identity theft attacks may be performed by a call initiator (e.g., such as the first device 202 of FIG. 2) to target the unauthorized capture (e.g., theft) of a called user's biometric data (e.g., such as the sensor and/or biometric data 246 and/or 256 corresponding to the user of the second device 206 of FIG. 2). The biometric data or information targeted in identity theft attacks may contain information indicative of and/or representative of the called user's voice, appearance, gestures, movement patterns, etc. In some examples, an identity theft attack performed by a user of the first device 202 and targeting a user of the second device 206 can correspond to the unauthorized capture of the receiving user's sensor and/or biometric information 246, which may be leaked before the interactive communication session 250 based on the receiving user's device (e.g., second device 206) performing the early session activation 242. In another example, an identity theft attack can correspond to the first device 202 initiating and transmitting a fake or scripted (e.g., automated, etc.) call request message 232 to the second device 206, with unauthorized capture of the receiving user's sensor and/or biometric information 256 performed during the ongoing interactive communication session 250.

In some aspects, the systems and techniques described herein can be used to perform authentication of attestation information of a calling party that is provided in an incoming call initiation request received from the calling party. In some examples, the systems and techniques can prevent and/or mitigate fake video call attacks and other identity theft attacks targeting user biometric information, based on the systems and techniques being configured to determine a user intent to communicate or participate in an interactive communication session, wherein biometric information and/or sensor data obtained by the user's device is not streamed to the initiator of the interactive communication session until the user intent to communicate or participate has been determined or confirmed.

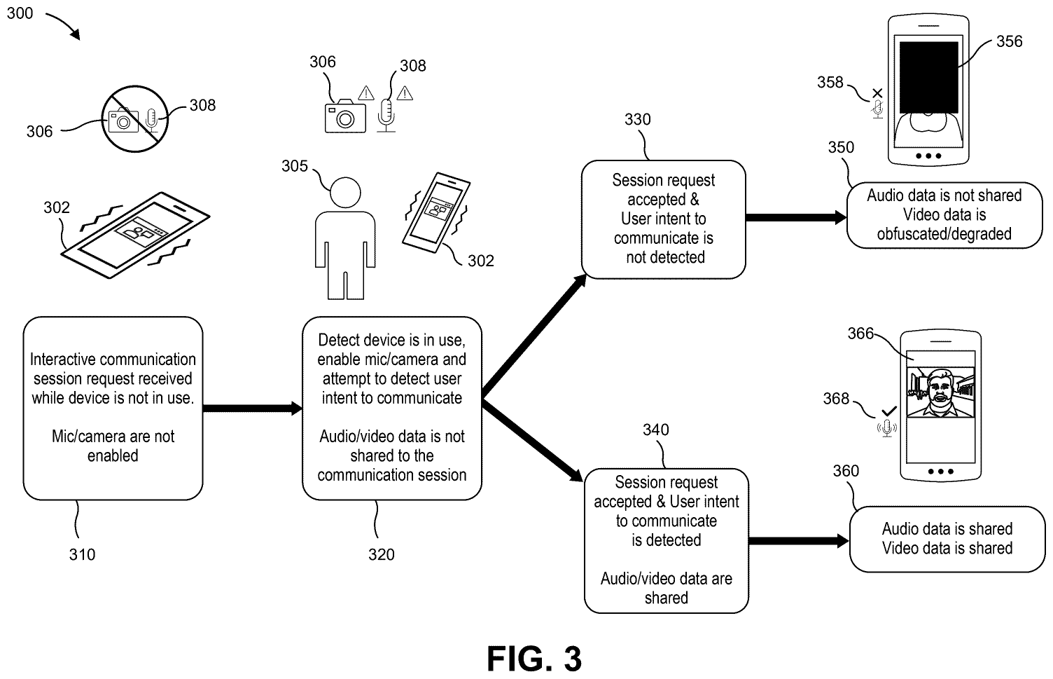

For example, FIG. 3 is a diagram illustrating an example of an interactive communication session 300 that is performed by a call recipient user device 302 based on a first data sharing configuration that obfuscates or blocks the transmission of user biometric data in response to an unsuccessful authentication result for attestation information included in a call initiation request, and a second data sharing configuration that permits or enables the transmission of user biometric data in response to a successful authentication result for the attestation information corresponding to the calling party and included in the call initiation request.

In some aspects, the call recipient user device 302 may be the same as or similar to the second device 206 of FIG. 2. For example, the call recipient user device 302 can receive an incoming interactive communication session request (e.g., a call request message) transmitted by a call initiator user device. The incoming interactive communication session request received by the call recipient user device 302 of FIG. 3 can be the same as or similar to the interactive communication session request message 232 transmitted by the call initiator user device 202 of FIG. 2.

In one illustrative example, the call recipient user device 302 can implement the interactive communication session 300 using a selection between a first and second configuration for sharing of the call recipient user's biometric data to the interactive communication session with the call initiator user. The selection between the first and second biometric user data sharing configurations may be based on the call recipient user device 302 detecting or not detecting a user intent to communicate, in accordance with some examples. In some aspects, a first user intent to communicate can be determined corresponding to a first user (e.g., the call initiator user), and a second user intent to communicate may be determined corresponding to a second user (e.g., the call recipient user, such as a user of the call recipient user device 302). In some examples, a user intent to communicate is determined for the call initiator user and is not determined for the call recipient user. In some cases, a user intent to communicate is determined for the call recipient user and is not determined for the call initiator user.

In some cases, the user intent to communicate can be determined using passive sensors included in the respective user's device. For example, a call initiator user intent to communicate can be determined using passive sensors included in the call initiator user device. A call recipient user intent to communicate can be determined using passive sensors included in the call recipient user device. In some examples, the passive sensors may be the same as or different from a set of one or more sensors of the user's device that are used for the interactive communication session. For example, the one or more sensors of the respective user device (e.g., call initiator device, call recipient device) that are used for the interactive communication session can include one or more microphones or other audio capture sensors, one or more cameras or other image capture sensors, etc. In some cases, the passive sensors of the respective user device (e.g., call initiator device, call recipient device) that may be used for determining the respective user intent to communicate and/or that are not used for the interactive communication session can include one or more of an accelerometer, a gyroscope or gyro sensor, an inertial measurement unit (IMU), an inertial navigation system (INS), etc. For example, an accelerometer, gyroscope, IMU, or other inertial sensor can be used to determine a device pick up gesture or movement that is performed by the respective user and indicative of a corresponding user intent to communicate, etc.

In one illustrative example, a user is a recipient of video call request as the interactive communication session. The systems and techniques can be used to determine the call recipient user intent to communicate (e.g., intent to accept and/or participate in the incoming video call request) before configuring the call recipient user device to begin streaming audio and/or voice data, image data, video data, and/or other sensor data of the call recipient that includes or reveals biometric information of the call recipient. In some cases, the user intent to communicate can be determined verbally, can be determined based on an intent to communicate signal or indication that is generated in response to audio keyword recognition performed to recognize one or more keywords spoken by the user during the incoming video call request, etc. In another example, the user intent to communicate signal or indication can be generated by the call recipient user device based on gesture recognition performed using one or more active sensors of the call recipient user device. For example, the orientation of the call recipient user device in a face-down (e.g., display-down, etc.) position or a resting position on a surface such as a table can be used to infer a negative intent to communicate signal and/or a lack of a positive (e.g., affirmative) intent to communicate signal corresponding to the call recipient user. Based on a negative intent to communicate signal or a lack of a positive intent to communicate signal being determined by the call recipient user device for the call recipient user at the time of an incoming call initiation request being received, the call recipient user device can be configured to not stream audio and/or video data of the user to the incoming video call request.

For example, at block 310 of the communication session 300, the call recipient user device 302 can receive an interactive communication session request from a call initiator user device. The interactive communication session request can be received by the call recipient user device 302 while the call recipient user device 302 is not in use. Before receiving the interactive communication session request, a microphone 308 and a camera 306 included in the call recipient user device 302 are in a disabled or off state (e.g., based on the call recipient user device 302 being not in use prior to and when the incoming communication session initiation request is received). The microphone 308 and the camera 306 of the call recipient user device 302 can remain in the disabled or power-off state after the incoming communication session initiation request is received (e.g., the microphone 308 and the camera 306 of the call recipient user device 302 are not enabled).

The call recipient user device 302 can detect, at block 320, that the call recipient user device 302 is now in use, for example corresponding to a lifting or user pick-up gesture or motion that is performed by the call recipient user 305 and causes the call recipient device 302 to move. In some cases, the in-use detection may be determined by the call recipient device 302 based on analyzing accelerometer sensor data, gyroscopic sensor data, IMU sensor data, inertial sensor data, and/or various other passive sensor data that is obtained by corresponding sensors of the call recipient device 302.

In some examples, detecting the in-use state of the call recipient device 302 at block 320 can further cause the call recipient device 302 to begin detection of a user intent to communicate. For example, the call recipient device 302 can begin monitoring for a user intent to communicate, can attempt to identify, determine, or detect a user intent to communicate, etc. In some examples, detecting the in-use state of the call recipient device 302 can be the same as detecting a user intent to communicate. In other examples, detecting the in-use state of the call recipient device 302 can be separate from detecting a user intent to communicate.

In one illustrative example, based on detecting the in-use state of the call recipient device 302 and/or based on triggering the attempt to detect the affirmative user intent to communicate, at block 320 the call recipient device 320 may be configured to activate, enable, power-on, etc., one or more (or both) of the camera 306 and/or the microphone 308 of the call recipient device 302. For example, the camera 306 and microphone 308 are in the disabled state in block 310, and in block 320 may be activated from their respective disabled states, based on the device in-use detection and/or based on the triggering of the attempt to detect the user intent to communicate.

In block 320, the camera 306 and/or microphone 308 can be used to perform active sensing to perform the detection of the user intent to communicate. In some aspects, the camera 306 and/or microphone 308 are enabled at block 320, but the call recipient device 302 does not share respective image data or audio data captured by the enabled camera 306 or the enabled microphone 308. For example, the camera 306 can capture image data of the user 305 that is analyzed locally by the call recipient device 302 to attempt to detect the user intent to communicate, and the microphone 308 can capture audio data or voice data of the user 305 that is analyzed locally by the call recipient device 302 to attempt to detect the user intent to communicate. The call recipient device 302 can be configured to disable or prevent the sharing of any image data from the camera 306 to the communication session and associated call initiator device, and can be configured to disable or prevent the sharing of any audio or voice data from the microphone 308 to the communication session and associated call initiator device.

At block 330, the call recipient device 302 receives one or more user inputs indicative of acceptance of the incoming interactive communication session request of block 310, and further determines that a user intent to communicate has not been detected at the time of the user 305 accepting the incoming communication session request. For example, the call recipient device 302 can receive the one or more user inputs indicating the call recipient user 305 acceptance of the incoming communication session request, and in response can evaluate if the user intent to communicate has been detected. If the evaluation results in a determination by the call recipient device 302 that an affirmative user intent to communicate has not been detected and/or that a negative user intent to communicate has been detected, the call recipient device 302 can implement the communication session based on a first configuration 350, corresponding to removing or masking (e.g., blurring, occluding, applying distortions to, etc.,) at least a portion of biometric information of the call recipient user 305 from being shared, streamed, and/or transmitted to the call initiator device during the ongoing communication session that was accepted at block 330.

For example, the first configuration associated with block 350 can correspond to a configuration of user biometric data sharing that prevents or reduces the sharing of biometric information of the call recipient user 305 during the ongoing communication session. In one illustrative example, the incoming interactive communication session request may be accepted by the call recipient user 305 and/or the call recipient device 302 without determining, or before determining, the positive intent to communicate signal or indication for the call recipient at block 320. In such examples, the call recipient device 302 can be configured, based on the first configuration 350, to perform the accepted communication session while limiting or preventing the sharing of biometric information of the call recipient user 305 in the data that is transmitted or streamed by the call recipient device 302 during participation in the accepted communication session with the call initiator device and call initiator user. For example, audio or voice data from the microphone 308, image or video data from the camera 306, and/or various other sensor data obtained by sensors included in the call recipient device 302, etc. can be obtained and transmitted by the call recipient device 302 to the call initiator device during the ongoing communication session. Based on the affirmative user intent to communicate not being determined at blocks 320 and/or 330, or based on a negative user intent to communicate being determined at blocks 320 and/or 330, the call recipient device 302 can implement the communication session using the restricted biometric data sharing configuration 350.

In one illustrative example, the restricted biometric data sharing configuration 350 corresponds to the call recipient device 302 being configured to hide, blur, mask, occlude, or otherwise modify or distort one or more of the sensor data streams that are transmitted from the call recipient device 302 to the calling party (e.g., the initiator of the interactive communication session request). For example, the audio of the call recipient user 305 obtained from the microphone 308 may be downsampled or reduced in quality, can be modulated or distorted to change or hide the biometric or unique characteristics of the user's true voice/speech, etc. In another example, video or image data of the call recipient user 305 obtained from the camera 306 can be disabled and the camera(s) 306 of the call recipient device 302 can remain in an off state until a configured keyword, gesture, action, etc., is detected or recognized indicative of a positive intent to communicate signal from the user.

In some cases, the restricted biometric information sharing configuration 350 for the communication session 300 can correspond to the call recipient device 302 being configured to process one or more inputs corresponding to biometric information of the user (e.g., audio data from microphone 308, image data from camera 306, etc., corresponding to biometric information of the call recipient user 305, etc.) to generate one or more obfuscated inputs for transmitting from the call recipient device 302 to the call initiator device and the communication session 300. For example, the one or more obfuscated inputs can be generated by processing the audio data inputs obtained from microphones 308, the image data inputs obtained from cameras 306, and/or processing sensor data inputs obtained from various other sensors of the call initiator device 302 using a quality reduction codec. In some aspects, using the quality reduction codec can correspond to generating and transmitting to the call initiator device and the communication session 300 obfuscated data or obfuscated representations of the original user inputs that included biometric information of the call recipient user 305. The quality reduction codec can generate obfuscated data representations where the video or image data of the call recipient user 305 can be blurred, masked, distorted, modified, etc., to hide the biometric characteristics of the call recipient user 305 until the positive intent to communicate signal is detected. In some aspects, the quality reduction codec and can be configured to reduce an original resolution of the input data and/or to reduce an original sampling rate of the input data.

For example, the restricted biometric information sharing configuration 350 can include processing the original image data captured by the camera 306 of the call recipient device 302 to generate obfuscated image data with an overlay (e.g., blurring mask, occluding mask, etc.) 356 that blocks, occludes, obscures, etc., at least a portion of the original image data corresponding to a face of the call recipient user 305 and/or one or more portions of the original image data that indicate, represent, or reveal biometric information corresponding to the call recipient user 305. In some cases, the obfuscated image data with the overlay or mask 356 can be generated based on using a quality reduction codec to process the original image data from the camera 306 of the call recipient device 302 to thereby generate the corresponding obfuscated image data including the overlay mask 356 codec (e.g., where the quality reduction codec can be configured to reduce an original resolution of the input data and/or to reduce an original sampling rate of the input data). In some aspects, the restricted biometric information sharing configuration 350 can be implemented to cause the call recipient device 302 to disable the microphone 308 of the call recipient device 302 so that audio data (e.g., indicative of voice biometric characteristics or information of the call recipient user 305) is not shared to the call initiator or communication session. In some examples, the original audio data obtained by the enabled microphone 308 of the call recipient device 302 can be processed using a quality reduction codec to generate an obfuscated audio input 358 that does not include biometric voice characteristics or other biometric information of the call recipient user 305. In some aspects, original audio data from microphone 308 is not shared by the call recipient device 302 in the restricted biometric information sharing configuration 350, and only the obfuscated audio data 358 generated using the quality reduction codec is shared. In some cases, the obfuscated inputs generated by the quality reduction codec can be associated with a second quality level that is lower than a first quality level associated with the original inputs that include the user biometric information. In some examples, the quality reduction codec can be configured to reduce one or more of an original resolution associated and/or an original sampling rate associated with the one or more inputs of audio data from microphone 308 and/or the one or more inputs of image data from camera 306. In some cases, the quality reduction codec can apply one or more audio distortions to the audio data from microphone 308.

In another illustrative example, based on detecting the user intent to communicate at block 320, the call recipient device 302 can proceed to block 340, corresponding to the user acceptance of the incoming communication session initiation request and an affirmative detection of a user intent to communicate. At block 340, the call recipient device 302 can be configured to perform the communication session according to a second configuration 360, where the audio data from microphone 308 is shared to the communication session and call initiator device as the original or non-degraded audio data 368 that includes the call recipient user 305 biometric information, and where the image data from camera 306 is also shared to the communication session and call initiator device as the original or non-degraded image data 366 that includes the call recipient user 305 biometric information.

In another example, the call recipient user 305 may receive an incoming request for a video call or other interactive communication session from a call initiator device and call initiator user. Prior to receiving the call request, the camera(s) 306 and microphone(s) 308 of the call recipient device 302 can be disabled and/or are not actively enabled to capture video or audio data of the call recipient user 305. In some aspects, passive sensors of the call recipient device 302 (e.g., accelerometer, gyro, IMU, light/proximity, etc.) can be used to detect a pick-up gesture corresponding to the call recipient user 305 picking up the call recipient device 302 with an intent to communicate (e.g., as in block 320 and/or block 340 of FIG. 3). The intent to communicate determined from the passive sensors can trigger the activation or enabling of the audio and video capture by the call recipient device 302 (e.g., as in block 320, 340, and/or 360 of FIG. 3, etc.), but without yet transmitting the audio or video data to the video call or interactive communication session corresponding to the incoming request.

In some aspects, the microphone 308 and capture of audio or voice data biometric information of the call recipient user 305, and/or the camera 306 and capture of image or visual data biometric information (e.g., corresponding to anatomy) of the call recipient user 305, can be enabled on the call recipient device 302 to perform a secondary verification of the user intent to communicate in the context of the incoming request for the video call or other interactive communication session. For example, the audio and/or image data can be enabled and used to monitor for a configured keyword, gesture, motion, etc., from the call recipient user 305 (e.g., at block 320) that indicates an intent to participate and communicate in the requested video call or other requested interactive communication session. Until the keyword or gesture is detected indicating the intent to participate in the interactive communication session 300, audio and video data captured by the call recipient device 302 are not shared with or streamed to the incoming video call or other interactive communication session, and are not shared with or streamed to the corresponding call initiator user.

In some aspects, the call recipient user 305 may accept the incoming call request but does not speak the keyword or perform the gesture indicative of intent to communicate and participate. The incoming video call or other interactive communication session is established and ongoing, but the call recipient user 305 audio and video data obtained by the corresponding sensors of the call recipient device 302 are blocked from being shared with the call or communication session, and are blocked from being shared with the associated call initiator user and call initiator device. For example, the call recipient user 305 audio may show as muted (e.g., as in the first, restricted biometric information sharing configuration 350 of FIG. 3) and the call recipient user 305 video may show as obstructed, hidden, or unavailable (e.g., as in the first, restricted biometric information sharing configuration 350 including the obfuscated image data 356, etc.). Based on the call recipient user 305 speaking a configured keyword and/or performing a configured gesture (e.g., double tap, hand wave, etc.,) corresponding to a positive or affirmative intent to communicate that is detected by the call recipient device 302, the call recipient user 305 audio and video data with biometric information of the call recipient user 305 can be shared with the video call or other interactive communication session, based on an intent to communicate and/or participate being detected for the call recipient user. In some examples, a count-down can be triggered based on the call recipient device 302 detecting the spoken keyword or gesture by the call recipient user 305, indicating that sharing of the call recipient user 305 audio and video data will be performed at the end of the countdown, unless the call recipient user 305 aborts the data sharing within the time period of the countdown (e.g., before the countdown ends).

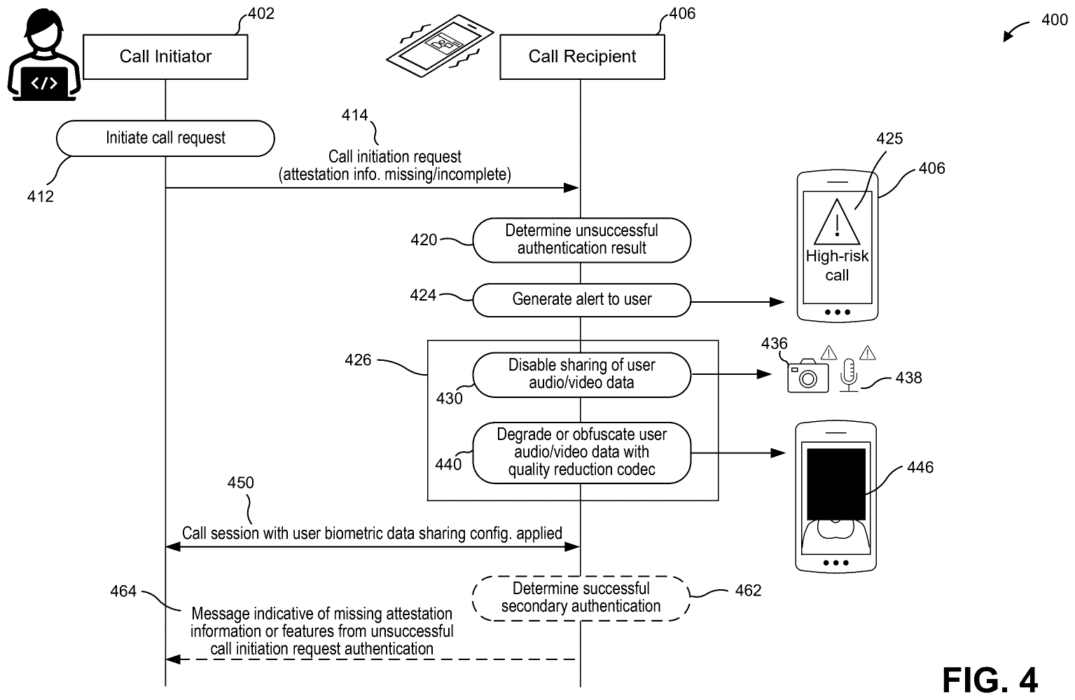

FIG. 4 is a signaling diagram illustrating an example of a communication session 400 configured to use a restricted user biometric sharing configuration based on a call recipient device (e.g., call receiver 406) determining an unsuccessful authentication of a call initiation request received from (e.g., transmitted by) a call initiator device (e.g., call initiator 402). In one illustrative example, the unsuccessful authentication associated with the example communication session 400 can be determined by the call receiver 406 based on attestation information corresponding to the call initiator 402. The call receiver 406 can perform the call or communication session with a user biometric data sharing configuration that is implemented based on the unsuccessful authentication result, in accordance with some examples.

In some aspects, the call initiator 402 of FIG. 4 can be the same as or similar to one or more of the first device 202 of FIG. 2, and/or a call initiator device associated with the communication session 300 of FIG. 3, etc. In some examples, the call receiver 406 of FIG. 4 can be the same as or similar to one or more of the second device 206 of FIG. 2, the call recipient device 302 of FIG. 3, etc.

In one illustrative example, the unsuccessful authentication result (e.g., the unsuccessful authentication result 420 determined by the call receiver 406) determined in the example communication session 400 of FIG. 4 can be based on the call initiator 402 performing a scripted (e.g., automated, etc.) process to initiate a call request at block 412. For example, the systems and techniques can determine the unsuccessful authentication result 420 in examples where the call initiator 402 transmits a call initiation request 414 using a scripted or automated call that is placed to the call receiver 406. In some aspects, a call initiation request 414 that is transmitted based on execution of a script or automated calling process by the call initiator 402 can correspond to an identity theft attack (e.g., fake call attack) against the call receiver 406 and/or the victim user of the call receiver device.

In some examples, attestation can be implemented or performed for the party initiating a call or other interactive communication session request. For example, attestation can be performed for the call initiator user based on the call initiator device 402 being configured to determine attestation information indicative of an intent to communicate by the call initiator user and/or indicative of a legitimate human user acting as the call initiator to transmit a call initiation request to the recipient device 406. For example, attestation information of the initiating party can be used to verify and/or authenticate the identity of the initiating party, which can reduce or prevent the incidence of fake call attacks, identity theft attacks, etc. Based on attestation information, the initiating party can be authenticated as a genuine caller and not a “robo-caller” such as may often be used for performing fake video call attacks and identity theft attacks. In some cases, the authentication of the initiating party (e.g., also referred to as the calling party) can be performed on the call initiation end of the communication session, for example using the same device with which the initiating party sends the request to initiate the interactive communication session. In one illustrative example, the attestation information can be based on sensor data corresponding to or indicative of one or more gestures performed by the initiating party, can be based on one or more sensor data or biometric features detected for the initiating party, etc.

In some aspects, the call recipient device 406 can receive the incoming call initiation request 414 and can analyze the call initiation request 414 to determine if attestation information is included within or indicated by the call initiation request 414. In some examples, the call recipient device 406 can determine the unsuccessful authentication result 420 based on a determination that the incoming call initiation request 414 does not include any attestation information (e.g., attestation information is missing from the call initiation request 414).

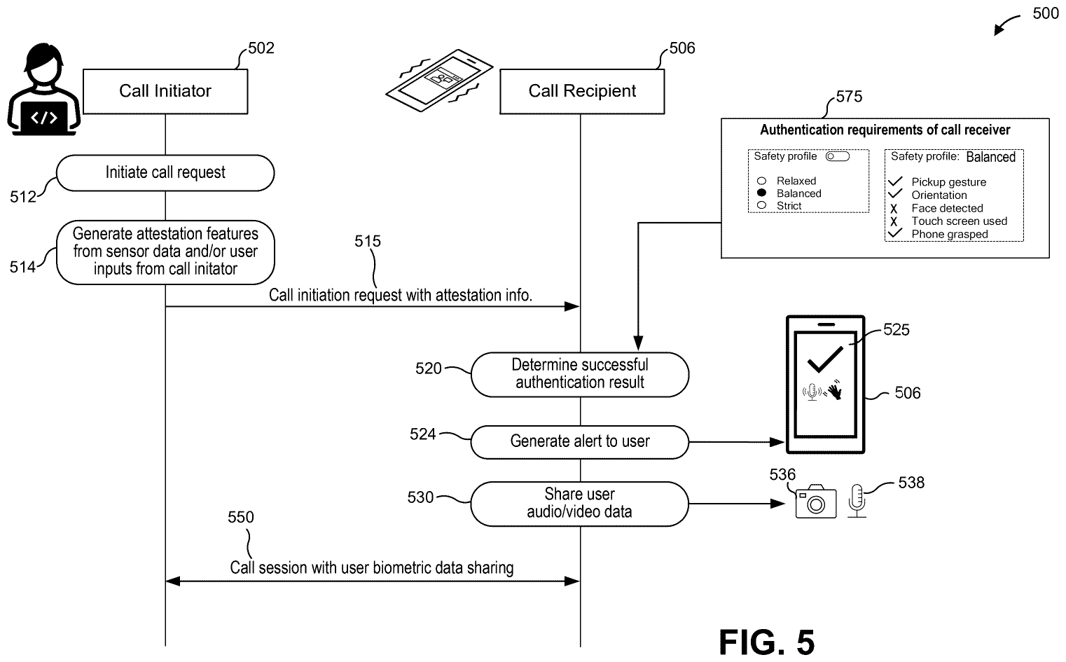

In some examples, the call recipient device 406 may determine the unsuccessful authentication result 420 based on a determination that attestation information included in the call initiation request 414 is incomplete, invalid, incorrect, etc. For example, the unsuccessful authentication result 420 can correspond to a determination by the call recipient device 406 that the attestation information of the call initiation request 414 does not match or does not pass one or more authentication requirements and/or authentication criteria that are configured for the call recipient device 406. In some examples, the authentication requirements or authentication criteria configured for the call recipient device 406 and used to determine the authentication result (e.g., the unsuccessful authentication result 420 of FIG. 4, the successful authentication result 520 of FIG. 5, etc.) can be referred to as authentication configuration information associated with a user of the call recipient device 406. For example, the authentication requirements or authentication criteria configured for the call recipient device 406 can be based on a user safety profile or user preference information that is provided by the call recipient user as input to the call recipient device 406. The authentication requirements or authentication criteria (e.g., the authentication configuration information) can be stored locally by the call recipient device 406, for example in a memory or other data storage included in the call recipient device 406.

In some examples, the determination of the unsuccessful authentication result 420 can be based on the call recipient device 406 comparing the received caller attestation information of the call initiation request 414 with the one or more authentication requirements or authentication criteria that are included in the authentication configuration information associated with the call recipient user of the call recipient device 406 (e.g., the call recipient user safety profile or preferences, etc.).

Based on determining the unsuccessful authentication result 420, the call recipient device 406 can be configured to generate an alert 424 to the call recipient user, where the alert 424 is indicative of the determination of the unsuccessful authentication result 420. In some examples, the unsuccessful authentication alert 424 can be displayed to the call recipient user on a display 425 and/or graphical user interface (GUI) thereof of the call recipient device 406. For example, the call recipient device 406 can be alerted to incoming calls that are detected, identified, or classified as “high-risk” in the absence of authentication or attestation (e.g., the high-risk determination may correspond to the call initiation request 414 not including any caller attestation information, and/or may correspond to the call initiation request 414 not meeting or passing any of the configured authentication requirements of the call recipient user's configured safety profile, etc.). For example, if caller attestation information is not available for the call initiator 402, or if the caller attestation information is included in the call initiation request 414 but fails authentication by the call recipient device 406 (e.g., the unsuccessful authentication result 420 is determined), the call recipient user of the interactive communication session 400 can be notified by the alert 424 that the incoming call initiation request 414 is from a non-authenticated calling party (e.g., the alert 424 indicates that the call initiator 402 associated with the incoming call initiation request 414 has been determined to be a non-authenticated calling party). In some cases, the call recipient user can be notified (e.g., by the generated alert 424) that the incoming call initiation request 414 has been identified or classified as a high-risk session, based on the lack of attestation and/or authentication attached to the session.

In one illustrative example, for an incoming communication session request 414 identified as high-risk (e.g., no attestation, not authenticated, etc.), the call recipient user can be presented with a choice to accept the high-risk call and publish (e.g., share or transmit) his or her audio data, video data, and/or other biometric information to the call initiator 402 associated with the call initiation request 414 and the unsuccessful authentication result 420. For example, the call recipient user can provide one or more inputs to acknowledge and dismiss the generated alert 424 indicative of the high-risk classification or determination for the incoming call initiation request 414 and corresponding un-authenticated call initiator 402. In some examples, the generated alert 424 can include an option for the call recipient user to decline the high-risk call (e.g., not accepting the incoming call initiation request 414, and not performing the request communication session with the call initiator 402).

In another illustrative example, the systems and techniques can configure the call recipient device 406 to perform restricted biometric information sharing for the call recipient user during the communication session with the unauthenticated call initiator 402. For example, the call recipient device 406 can configure the communication session 400 between the call initiator 402 and the call recipient device 406 based on a restricted biometric information sharing configuration 426. In some aspects, the restricted biometric information sharing configuration 426 can cause the call recipient device 406 to disable data sharing at block 430 for one or more types of sensor data obtained by the call recipient device 406 (e.g., one or more types of sensor data, such as audio data and/or video data, that would normally be obtained by the call recipient device 406 and shared to the call initiator 402 and communication session 400). For example, disable data sharing configuration 430 can represent causing the call recipient device 406 to disable data sharing of user audio data (e.g., audio data of the call recipient user, obtained from a microphone 438 included in the call recipient device 406, etc.) and/or to disable data sharing of user image or video data (e.g., image or video data of the call recipient user, obtained from a camera 436 included in the call recipient device 406, etc.).

In some aspects, the restricted biometric information sharing configuration 426 can include a quality degradation codec 440, which causes the call recipient device 406 to process the obtained user audio data from microphone 438 and/or the obtained user image data from camera 436 to generate respective obfuscated data that masks, hides, or removes the biometric information of the call recipient user. In some aspects, the quality reduction codec 440 used to generate the degraded or obfuscated user audio and/or video data in the communication session 400 of FIG. 4 can be the same as or similar to the quality reduction codec used in the configuration 350 of FIG. 3 to generate the degraded or obfuscated user audio 358 and the degraded or obfuscated user image or video data 356. For example, the quality reduction codec 440 of FIG. 4 can be used to generate the degraded or obfuscated user video data to remove or mask biometric information of the call recipient user based on generating or applying an overlay mask 446 over a portion of the image data corresponding to or including a representation of the face, anatomy, or other visual biometric information of the call recipient user (e.g., where visual biometric information corresponds to anatomy of the call recipient user). In some examples, the overlay mask 446 generated by the quality reduction codec 440 of FIG. 4 can be the same as or similar to the overlay mask of the degraded or obfuscated user image or video data 356 of FIG. 3. In some aspects, the quality reduction codec 440 of FIG. 4 can apply one or more audio distortions to the audio data to generate the obfuscated inputs.

The quality reduction codec can be used by the call recipient device 406 to process at least a portion of the sensor data that is obtained by the call recipient device 406 for transmitting to the call initiator 402 during the interactive communication session corresponding to the call initiation request 414. In some examples, the use of the quality reduction codec 440 can be in response to the determination of the unsuccessful authentication result 420 by the call recipient device 406. For example, the call recipient device 406 can process the original quality audio data of the user (e.g., the audio data obtained from microphone 438, the video or image data obtained from camera 436, etc.) using the quality reduction codec 440 to generate a respective obfuscated audio input and a respective obfuscated image or video input. The obfuscated audio and image or video inputs generated by the quality reduction codec 440 (e.g., among various other obfuscated inputs that can be generated by the quality reduction codec 440) can have a lower quality than the original quality input obtained by the sensors of the call recipient device 406, and may remove or reduce the quantity of biometric information of the call recipient user that is included in the data shared with or transmitted to the call initiator 402 during the interactive communication session 450 corresponding to the call initiation request 414 that received the determination of the unsuccessful authentication result 420.

For example, the quality reduction codec 440 and/or the restricted user biometric information sharing configuration 426 can be used to configure the call recipient device 406 to perform the call session 450 with the user biometric data sharing configuration implemented to restrict, limit, and/or prevent the sharing of the biometric information of the call recipient user. The biometric data sharing configuration to restrict, limit, and/or prevent the sharing of the biometric information of the call recipient user can prevent an identity theft attack or fake call attack that may be performed against the call recipient user by the unauthenticated call initiator 402. In some aspects, during the call session 450 with the restricted user biometric data sharing configuration applied, the call recipient device 406 may publish, to the call session 450 and call initiator 402, a modified version of the call recipient user data (e.g., audio data, video data, biometric information, etc.) that has been adjusted or processed to mask or remove the biometric information or other identifiable information of the call recipient.

In one illustrative example, the audio data, video data, and/or other sensor data of the call recipient user can be processed using a “low-quality” codec implemented by the call recipient device 406. In some cases, the quality degradation codec 440 and the low-quality codec may be the same, and can be configured to reduce an original resolution of the input data and/or to reduce an original sampling rate of the input data. In some examples, the audio and/or video bitrate or quality can be intentionally degraded based on processing the user audio data and/or the user video data with the low-quality codec and/or the quality degradation codec 440, to generate corresponding obfuscated audio and video inputs that can be shared to the call session 450 and call initiator 402 while avoiding or preventing the exposure of the call initiator user's biometric information or other potentially identifiable information of the call initiator user. For example, the obfuscated user inputs can be generated and shared to the communication session based on the restricted biometric data sharing configuration triggered by the unsuccessful authentication result 420. The obfuscated user inputs can be transmitted by the call recipient device 406 when accepting an incoming request for an interactive communication session (e.g., when accepting a high-risk non-authenticated call, and/or in scenarios where the call is non high-risk or is authenticated but the user chooses to process their audio/video with the low quality codec). In some examples, attestation can be performed to authenticate the call initiator 402 as genuine before the call is accepted by the call recipient device 406. In some examples, attestation can be performed continuously or periodically throughout the ongoing call or communication session 450. In some cases, continuous or periodic attestation throughout the call or interactive communication session can be configured for deepfake detection, etc.

In some aspects, the call recipient device 406 can be configured to perform a secondary authentication for call initiators and call initiation requests that previously were classified with the unsuccessful authentication result 420. For example, as noted above, the unsuccessful authentication result 420 can be determined based on the call recipient device 406 determining that the call initiation request 414 is missing one or more attestation features configured as requirements for successful authentication for the call recipient device 406 and/or the call recipient user. In some examples, based on the call recipient device 406 being able to determine a successful secondary authentication 462 for the call initiator 402, the call recipient device 406 can be configured to transmit a message 464 to the call initiator 402 that indicates the reason(s) for the unsuccessful authentication result 420. For example, the message 464 can indicate the attestation features that were required by the user safety profile for a successful authentication result to be determined for the call recipient device 406, but were missing from the caller attestation information included in the call initiation request 414.

For example, the user safety profile configured for the call recipient device 406 may indicate authentication requirements of a pickup gesture detection, a face detection (e.g., among other examples of detection of biometric information corresponding to anatomy of the user), touch screen use detection, and device grasp gesture detection. To determine a successful authentication result for an incoming call initiation request received by the call recipient device 406, in an example, the user safety profile indicates that the call initiation request 414 must include caller attestation information that indicates the call initiator device 402 detected each one of the pickup gesture detection, the face detection, the touch screen use detection, and the device grasp gesture detection. Each type of detection can be referred to as an “attestation feature” or a “caller attestation feature.” For example, the pickup gesture detection can be a first caller attestation feature, the face detection can be a second caller attestation feature, the touch screen use detection can be a third caller attestation feature, and the device grasp gesture detection can be a fourth caller attestation feature, etc. In one illustrative example, a call initiation request 414 that includes caller attestation information indicating that the call initiator 402 detected three of the four required attestation features can cause the call recipient device 406 to determine the unsuccessful authentication result 420. In some examples, the message 464 transmitted from the call recipient device 406 to the call initiator 402 can be indicative of the remaining one of the four required caller attestation features that was missing and caused the unsuccessful authentication result 420.

In some aspects, the signaling diagram for the communication session 400 of FIG. 4 can correspond to the first configuration of blocks 320, 330, and 350 of FIG. 3. The signaling diagram for the communication session 500 of FIG. 5 can correspond to the second configuration of blocks 320, 340, and 360 of FIG. 3. For example, FIG. 5 is a signaling diagram illustrating an example of successful authentication of a call initiation request based on attestation information of the call initiator, where the call recipient device is configured to perform the request call or communication session with a user biometric data sharing configuration based on the successful authentication result.

In some examples, the communication session 500 of FIG. 5 is performed between a call initiator 502 and a call recipient 506. The call initiator 502 can be the same as or similar to the call initiator 402 of FIG. 4, the first device 202 of FIG. 2, and/or a call initiator device associated with the communication session 300 of FIG. 3, etc. In some aspects, the call recipient 506 of FIG. 5 can be the same as or similar to the call recipient device 406 of FIG. 4, the second device 206 of FIG. 2, the call recipient device 302 of FIG. 3, etc.

At block 512, the call initiator 502 can initiate a call request to perform a call or interactive communication session with the call recipient 506. In some aspects, the signaling diagram for the communication session 500 of FIG. 5 corresponds to an example of a successful authentication result (e.g., the successful authentication result 520), which may be determined based at least in part on the call initiator user (e.g., user associated with the call initiator device 502) being a legitimate human user initiating the call request at block 512. For example, the successful authentication result 520 can correspond to the detection of a real human performing the initiation 512 of the call request 515 (e.g., can correspond to a call initiator 502 that is not using scripted or automated execution of the call initiation 512 and transmission of the call initiation request 515, etc.).

The successful authentication result 520 can be determined based on attestation information (e.g., one or more attestation features, an attestation bitmask, etc.) that is determined by the call initiator 502 and included in the call initiation request 515 transmitted from the call initiator 502 to the call recipient 506. In one illustrative example, the call initiator 502 can generate attestation features 514 using sensor data and/or one or more user inputs received by the call initiator device 502 from the corresponding call initiator user (e.g., a user of the call initiator device 502 to perform the initiation 512 of the call request). The attestation features 514 can be generated based on detecting the intent to communicate for the user of the call initiator device 502, based on detecting one or more configured gestures or actions (e.g., phone pick up gesture, phone orientation, face detection (e.g., among other examples of detection of biometric information corresponding to anatomy of the user), touch screen use, phone grasped gesture or motion, etc.), and/or based on detecting utterance of one or more configured keywords or phrases by the call initiator user, and/or based on detecting one or more biometric signatures corresponding to the unique identity of a particular call initiator user, etc.

In some cases, the attestation features 514 can be detected by the call initiator 502 in response to the initiation 512 of the call request by the call initiator user. For example, after the initiation 512 of the call request is started by the call initiator device 502, the call initiator device 502 can access or obtain the corresponding sensor data of the call initiator user to determine a detection result (e.g., yes or no, detected or not detected, etc.) for one or more configured attestation features 514. In some cases, the attestation features 514 generated by the call initiator device 502 correspond to and indicate the detection (or non-detection) of each respective attestation feature of the one or more configured attestation features at a time that is concurrent with or later than the start of the initiation 512 of the call request 515. In some examples, one or more of the attestation features 514 can be detected or generated by the call initiator device 502 at a time prior to the initiation 512 of the call request 515. In some cases, a first subset or first portion of the generated attestation features 514 may be generated by the call initiator 502 prior to the initiation 512 of the call request 515, and a second or remaining subset of the generated attestation features 514 may be generated by the call initiator 502 during or after the initiation 512 of the call request 515.

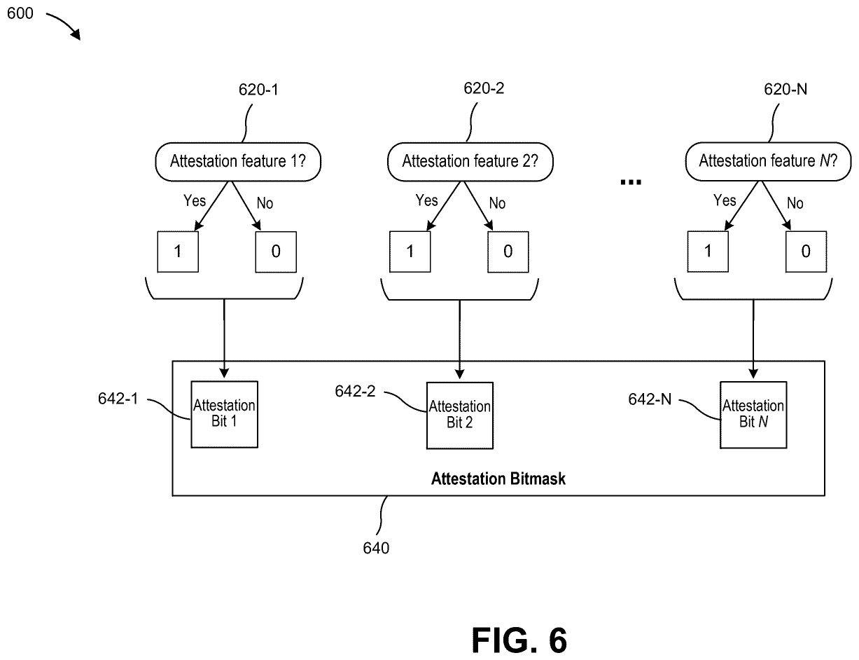

The generated attestation features 514 can be included in attestation information of the call initiator user that is attached or appended to the transmitted call initiation request 515 from the call initiator 502 to the call recipient 506. In one illustrative example, the generated attestation features 514 can be used to determine attestation information comprising an attestation bitmask that is included in the call initiation request 515. For example, the generated attestation features 514 and/or attestation information included in the call initiation request 515 of FIG. 5 may comprise and/or may be associated with the attestation bitmask 640 of FIG. 6.

FIG. 6 is a diagram illustrating an example of attestation information 600 comprising an attestation bitmask 640 that is generated based on a plurality of attestation feature detections 620-1, 620-2, . . . , 620-N. The attestation bitmask 640 can be included as caller attestation information of an interactive communication session or call initiation request, in accordance with some examples. For example, the caller attestation information of the call initiation request 515 of FIG. 5 and/or the caller attestation information of the call initiation request 414 of FIG. 4 can comprise an attestation bitmask the same as or similar to the attestation bitmask 640 of FIG. 6.

In some aspects, the attestation bitmask 640 includes a plurality of bits (e.g., attestation bits) 642-1, 642-2, . . . , 642-N each corresponding to a respective one of the attestation features 620-1, 620-2, . . . , 620-N and used to encode a detection result for the corresponding attestation feature by the call initiator device. For example, the attestation features 620-1, 620-2, . . . , 620-N can be a plurality of attestation features configured for detection by the call initiator device 402 of FIG. 4, 502 of FIG. 5, etc., such as during the attestation feature generation 514 of FIG. 5. A successful detection result of a particular attestation feature by the call initiator device can be encoded in the corresponding attestation bit within the attestation bitmask 640 using a first value (e.g., a value of ‘1’ mapped to the ‘Yes’ determination indicating that the particular attestation feature was detected by the call initiator device). An unsuccessful detection result, or the lack of a successful detection result, for the particular attestation feature by the call initiator device can be encoded in the same corresponding attestation bit (e.g., attestation bit position mapped to the particular attestation feature) using a second value different from the first value (e.g., a value of ‘0’ mapped to the ‘No’ determination indicating that the particular attestation feature was not detected by the call initiator device).

In some examples, attestation information can be generated or determined locally by the call initiator device. For example, the call initiator 402 of FIG. 4 and/or the call initiator 502 of FIG. 5 can determine attestation information (e.g., such as the attestation bitmask 640 of FIG. 6, etc.) without communicating with additional devices or systems, such as an authentication server, authentication service, authentication platform, authentication entity, external source of trust, etc.

The attestation information can be indicative of (e.g., attests to) the presence of one or more configured gestures or other attestation features that are associated with a real user initiating the call request 515 transmitted by the call initiator 502 to the call recipient 506. For example, the gestures associated with determining attestation information and indicated by the generated attestation information can be modality specific, modality agnostic, or both. In some aspects, the gestures or features that may be signaled by the attestation information indicative of a real user initiating the call can include one or more of detection of a pickup gesture performed by the initiating party at the time of call initiation, facial recognition of the initiating party at or during the call initiation, voice recognition of the initiating party at or during the call initiation, keyword detection, motion or movement detection (and/or motion pattern or movement pattern detection, etc.), and so on.

In one illustrative example, the attestation information can be signaled or provided to the receiving party as an attestation bitmask, such as the attestation bitmask 640 of FIG. 6. The attestation bitmask 640 can include a plurality of bit fields (e.g., corresponding to the attestation bits 642-1, 642-2, . . . , 642-N mapped to the attestation features 620-1, 620-2, . . . , 620-N, respectively) that can take a value of ‘0’ or ‘1’, with each different bit field or bit position within the attestation bitmask 640 corresponding to a particular type of recognized attestation information (e.g., gestures, features, or other indications of a real or genuine user being the initiating party). In some examples, a bit having a value of ‘0’ in the attestation bitmask 640 can indicate that the corresponding type of attestation information was not detected or is not present in association with the call request to which the attestation bitmask is attached. A bit having a value of ‘1’ in the attestation bitmask 640 can indicate that the corresponding type of attestation information was detected in associated with the call request to which the attestation bitmask is attached.

In some aspects, the attestation bitmask 640 and/or other caller attestation information included in the call initiation request 515 of FIG. 5 can be used by the call recipient 506 to determine an authentication result corresponding to the call initiation request 515 and/or corresponding to the call initiator 502 associated with the call initiation request 515. For example, the attestation bitmask 640 and/or other caller attestation information of the call initiation request 515 can be compared with one or more configured authentication requirements or authentication criteria 575 indicated by a user safety profile obtained and/or stored by the call recipient device 506 in association with the call recipient user.

For example, the attestation bitmask 640 and/or other caller attestation information of the call initiation request 515 can indicate the one or more attestation features that were detected by the call initiator device 502 in association with the initiation 512 of the call request 515. The detected attestation features indicated by the attestation bitmask 640 and/or other caller attestation information of the call initiation request 515 can be compared against the authentication requirements 575 to determine either the successful authentication result 520 of FIG. 5 or the unsuccessful authentication result 420 of FIG. 4.

Based on the determination of the successful authentication result 520, the call recipient device 506 can generate an alert 524 to the user, where the alert 524 is indicative of the successful authentication result 520. For example, the alert 524 can correspond to an indication 525 displayed on a screen and/or GUI of the call recipient device 506. In some cases, the alert 524 of the successful authentication result 520 can indicate that the microphone 538 and camera 536 of the call recipient device 506 will be enabled and used to capture and share, to the call session 550 and call initiator 502, respective audio and image/video data that includes biometric information of the call recipient user.

At block 530, the call recipient 506 can begin sharing or transmitting the user audio data (e.g., from microphone 538) with voice biometric information of the call recipient user to the call session 550 and the call initiator 502, and can additionally begin sharing or transmitting the user image data (e.g., from camera 536) with visual biometric information of the call recipient user to the call session 550 and the call initiator 502. In some aspects, the sharing of the user audiovisual data with biometric information of the call recipient at block 530 of FIG. 5 can be the same as or similar to the sharing of the user audiovisual data with biometric information of the call recipient at block 360 of FIG. 3.

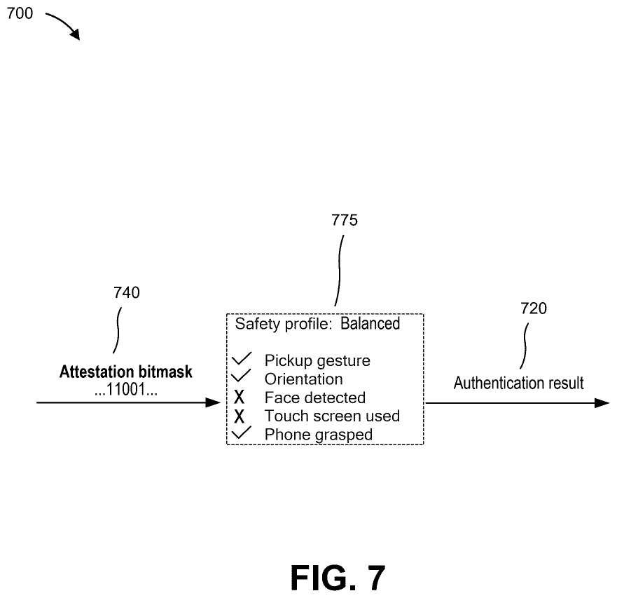

FIG. 7 is a diagram illustrating an example of authentication 700 that can be performed by a call recipient device (e.g., call recipient 302 of FIG. 3, call recipient device 406 of FIG. 4, call recipient 506 of FIG. 5, etc.) based on comparing caller attestation information included in a received call initiation request (e.g., attestation bitmask 740, etc.) to authentication configuration information associated with a user of the call recipient device (e.g., user safety profile 775).

In some aspects, the attestation bitmask 740 can be the same as or similar to the attestation bitmask 640 of FIG. 6, and can be included in the call initiation request 414 of FIG. 4, the call initiation request 515 of FIG. 5, etc. In some examples, the attestation bitmask 740 value sequence of ‘11001’ can indicate that a first attestation feature was detected by the call initiator device, a second attestation feature was detected by the call initiator device, a third and fourth attestation feature were not detected by the call initiator device, and a fifth attestation feature was detected by the call initiator device. In some aspects, the example authentication 700 can be performed by the call recipient device based on comparing the attestation bitmask 740 to the configured attestation requirements of the user safety profile 775. In some examples, the user safety profile 775 of FIG. 7 can be the same as or similar to the user authentication requirements 575 of FIG. 5.

For example, the successful authentication result 520 of FIG. 5 (e.g., and a successful authentication result 720 of FIG. 7) can correspond to a determination that the attestation bitmask 740 or other attestation information of the call initiation request 515 matches, satisfies, and/or passes the indicated authentication requirements and criteria of the user safety profile 775 (e.g., the authentication requirements and criteria 575 of FIG. 5) associated with the call recipient device and the call recipient user. For example, the authentication requirements 575 and/or 775 can indicate a set of attestation features, some or all of which must be present in the caller attestation information of the call initiation request in order for the call recipient device to determine the successful authentication result 520 and/or 720. In one illustrative example, the authentication requirements 575 and/or 775 may include the five authentication criteria of pickup gesture detected, orientation detection, face detection, touch screen use detection, and phone grasped gesture detection. The authentication requirements 575 and/or 775 may include various other authentication criteria, detection events, user inputs or actions, etc. In some aspects, the authentication requirements 575 and/or 775 can include a number of authentication criteria that is greater than five, less than five, equal to five, etc. Different safety profile levels (e.g., relaxed, balanced, strict) can correspond to different authentication requirements selected out of the set of five authentication criteria in the configured authentication information 575 and/or 775.

For example, a relaxed safety profile may correspond to determining the successful authentication result 520 and/or 720 based on any one or more of the five authentication criteria 575 and/or 775 being present (e.g., included within or indicated by the attestation bitmask 740 or other caller attestation information of the call initiation request).

In another example, the relaxed safety profile configuration can correspond to determining the successful authentication result 520 and/or 720 based on any two or more, etc., of the five authentication criteria 575 and/or 775 being present. In some examples, the relaxed safety profile can correspond to determining the successful authentication result 520 and/or 720 based on a configured minimum threshold number of authentication criteria being present out of either the entire plurality of configured authentication criteria 575 and/or 775 or out of a subset of the entire plurality of configured authentication criteria 575 and/or 775 (e.g., any two of the five authentication criteria 575 and/or 775, or any one of the subset of the five authentication criteria 575 and/or 775 comprising only face detection and touch screen use detection, etc.).

In some aspects, a balanced safety profile may be similar to the relaxed safety profile, and can implement a higher minimum threshold of the number and/or type(s) of detected authentication criteria out of the plurality of configured authentication criteria 575 and/or 775 that must be included or indicated by the attestation bitmask 740 or other caller attestation information of the call initiation request. In some aspects, a strict safety profile can implement a still higher minimum threshold of the number and/or type(s) of detected authentication criteria than the balanced safety profile. In some examples, a strict safety profile can require that each respective authentication criteria included in the call recipient user's configured plurality of authentication criteria 575 and/or 775 must be present or indicated in the attestation bitmask 740 or other caller attestation information of the call initiation request.

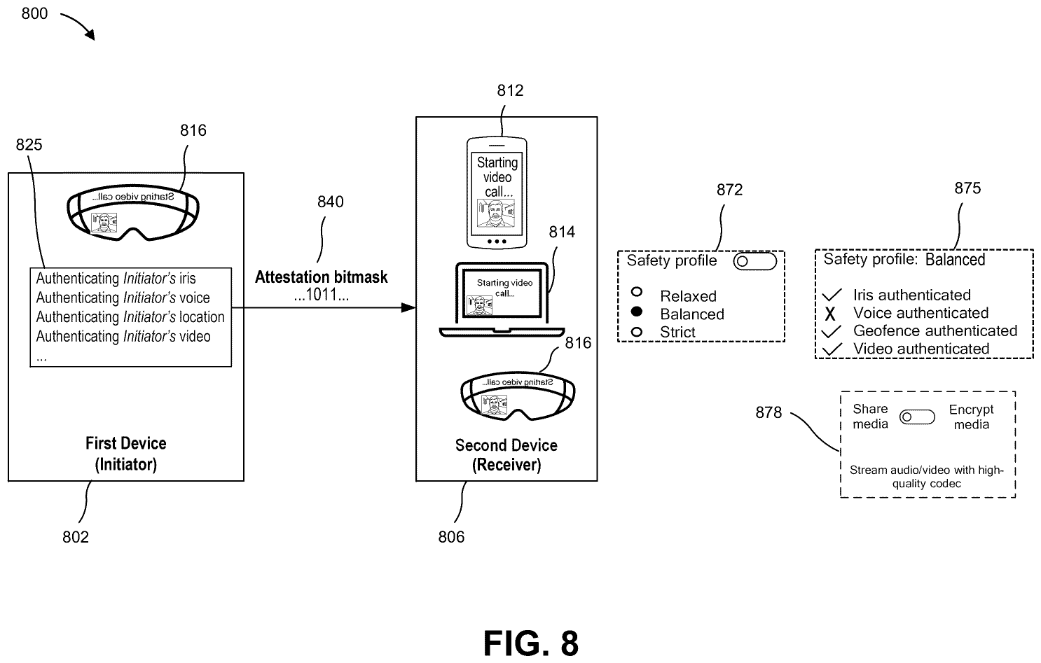

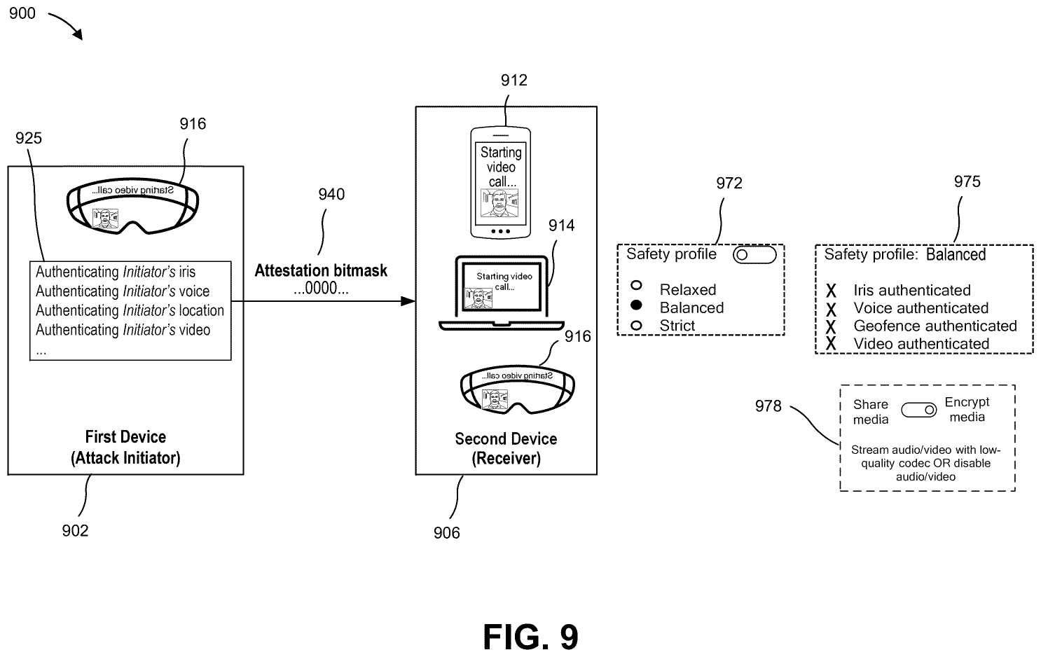

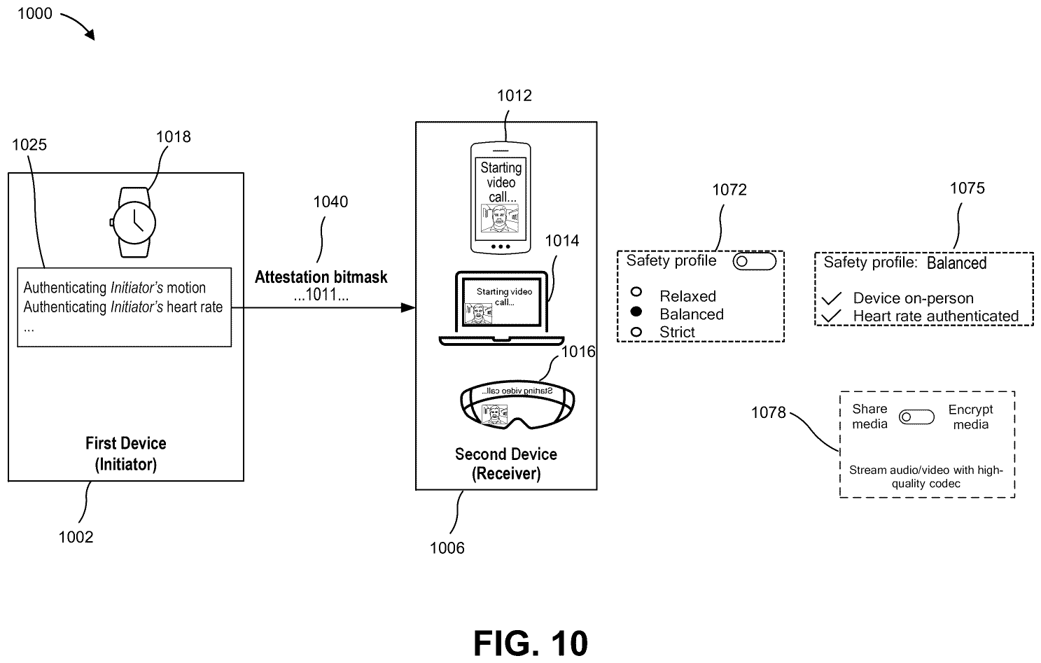

FIGS. 8-10 are diagrams illustrating examples of authentication results determined by a call recipient device based on comparing an attestation bitmask included in a call initiation request transmitted from a call initiator device to the call recipient device, with configured user safety profile information and/or authentication criteria included in authentication configuration information corresponding to the call recipient user. For example, FIG. 8 corresponds to an example of a successful authentication result determination 800, FIG. 9 corresponds to an example of an unsuccessful authentication result determination 900, and FIG. 10 corresponds to another example of a successful authentication result determination 1000.

In some aspects, a first device 802 of FIG. 8 can be the same as or similar to one or more of the call initiator devices 202 of FIG. 2, 402 of FIG. 4, 502 of FIG. 5, etc. The first device 802 of FIG. 8 can be the same as or similar to the first device 902 of FIG. 9 and/or the first device 1002 of FIG. 10. In some cases, a second device 806 of FIG. 8 can be the same as or similar to one or more of the call recipient device 206 of FIG. 2, 302 of FIG. 3, 406 of FIG. 4, 506 of FIG. 5, etc. The second device 806 of FIG. 8 can be the same as or similar to one or more of the second device 906 of FIG. 9 and/or the second device 1006 of FIG. 10.

In some aspects, the first device 802 of FIG. 8 and the first device 902 of FIG. 9 can be implemented as head-mounted devices (HMDs) 816 and/or 916, respectively. For example, the HMD 816 and/or 916 may be VR headsets, smart glasses, etc. In some cases, the HMD 816 and the HMD 916 can correspond to attestation features 825 and 925, respectively, that are generated corresponding the HMD modality of sensor data available to and/or obtained by the call initiator (e.g., first device 802, first device 902). For example, the attestation features 825 and 925 can comprise detection or authentication of the iris of the call initiator user, detection or authentication of the voice of the call initiator user, detection or authentication of the location of the call initiator user, detection or authentication of the video of the call initiator user, etc.

The HMD 816 call initiator features 825 can be used to generate a corresponding attestation bitmask 840 that is transmitted in a call initiation request from the first device 802 to the second device 806. The HMD 916 call initiator features 925 can be used to generate a corresponding attestation bitmask 940 that is transmitted in a call initiation request from the first device 902 to the second device 906. In some examples, the call initiator features 825 can be the same as or similar to the call initiator features 925, and the caller attestation bitmask 840 can be the same as or similar to the caller attestation bitmask 940. In some aspects, the caller attestation bitmask 840 and/or 940 can be the same as or similar to one or more of the caller attestation bitmask 640 of FIG. 6 and/or the caller attestation bitmask 740 of FIG. 7, etc.

In another illustrative example, the call initiator device can comprise a wearable, such as a smart watch, etc. For example, the first device 1002 (e.g., a call initiator device) can comprise the wearable or smart watch 1018, which may correspond to a different set of attestation features 1025 that are generated based on a different wearables modality of sensor data available to and/or obtained by the call initiator device (e.g., different from the HMD modality of sensor data obtained for the HMD attestation features 825 and/or 925). For example, the call initiator device comprising the smart watch or wearable 1018 of FIG. 10 can be used to determine attestation features 1025 that are based on detection or authentication of the motion of the call initiator user wearing the smart watch 1018, based on detection or authentication of the heart rate of the call initiator user wearing the smart watch 1018, etc. The attestation features 1025 can be used to generate an attestation bitmask 1040 that is the same as or similar to one or more of the attestation bitmasks 640 of FIG. 6, 740 of FIG. 7, 840 of FIG. 8, 940 of FIG. 9, etc.

In some aspects, the call recipient device (e.g., second device) 806 of FIG. 8, 906 of FIG. 9, and 1006 of FIG. 10 can be the same. For example, the call recipient devices 806, 906, and 1006 can comprise a smartphone or mobile computing device 812, 912, and 1012 (respectively). In another example, the call recipient devices 806, 906, and 1006 can comprise a laptop, desktop, tablet, or other user computing device 814, 914, and 1014 (respectively). In another example, the call recipient devices 806, 906, and 1006 can comprise an HMD 816, 916, and 1016 (respectively). The call recipient device and the call initiator device may be the same type of device, or may be different types of devices.

In the example of the successful authentication result determination 800 of FIG. 8, the call recipient device 806 compares the received attestation bitmask 840 with the authentication criteria 875 of the balanced safety profile 872 configured for the user of the call recipient device 806. For example, the balanced safety profile 872 can correspond to a successful authentication requirement of at least three attestation features of the configured four attestation features 875 (e.g., three of the four attestation features comprising iris authenticated, voice authenticated, geofence authenticated, video authenticated). Based on the successful authentication result determination 800, the call recipient device 806 can utilize a configuration 878 to perform the communication session with the call initiator device 802 with sharing of media, user data, or other indications of biometric information of the call recipient user enabled (e.g., can perform the communication session with streaming of audio and video data with a high-quality codec according to the configuration 878).

In the example of the successful authentication result determination 1000 of FIG. 10, the call recipient device 1006 compares the received attestation bitmask 1040 with the authentication criteria 1075 of the balanced safety profile 1072 configured for the user of the call recipient device 1006. For example, the balanced safety profile 1072 can correspond to a successful authentication requirement of at least the two attestation features of the configured attestation features 1075 (e.g., the two attestation features comprising device on-person detection and heart rate authenticated). Based on the successful authentication result determination 1000, the call recipient device 1006 can utilize a configuration 1078 to perform the communication session with the call initiator device 1002 with sharing of media, user data, or other indications of biometric information of the call recipient user enabled (e.g., can perform the communication session with streaming of audio and video data with a high-quality codec according to the configuration 1078). In some aspects, the configuration 1078 of FIG. 10 can be the same as the configuration 878 of FIG. 8.

In the example of the unsuccessful authentication result determination 900 of FIG. 9, the call recipient device 906 compares the received attestation bitmask 940 with the authentication criteria 975 of the balanced safety profile 972 configured for the user of the call recipient device 906. For example, the balanced safety profile 972 can correspond to a successful authentication requirement of at least one, at least two, at least three, . . . , etc., attestation features of the configured four attestation features 975 (e.g., three of the four attestation features comprising iris authenticated, voice authenticated, geofence authenticated, video authenticated). Based on the attestation bitmask 940 comprising the value sequence ‘0000’, no attestation features were detected or determined by the call initiator device 902 for the call initiator user, and the unsuccessful authentication result 900 is determined by the call recipient device 906.

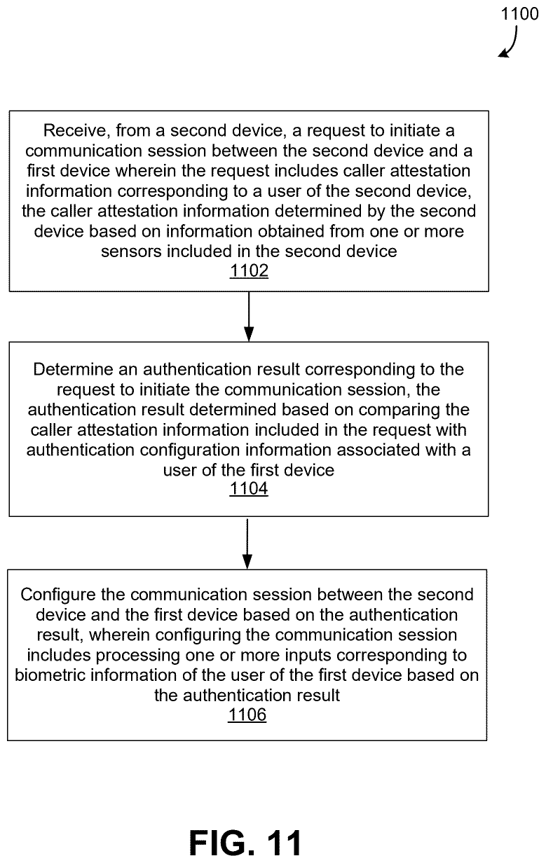

Based on the unsuccessful authentication result determination 900, the call recipient device 906 can utilize a restricted user biometric data sharing configuration 978 to perform the communication session with the call initiator device 902 without sharing of media, user data, or other indications of biometric information of the call recipient user enabled (e.g., can perform the communication session with streaming of audio and video data with a low-quality and/or quality reduction codec according to the configuration 978). In some aspects, the quality reduction codec of the configuration 978 can be the same as or similar to the quality reduction codec associated with generated degraded or obfuscated inputs at block 440 of FIG. 4. For example, the quality reduction codec can be configured to reduce an original resolution of the input data and/or to reduce an original sampling rate of the input data FIG. 11 is a flowchart diagram illustrating an example of a process 1100 for authentication and/or attestation of communications between user devices. In some examples, the process 1100 can be performed by a device associated with a call recipient (e.g., called party, call receiver, receiving party, etc.). In some examples, the process 1100 can be performed by a computing device or apparatus or a component or system (e.g., one or more chipsets, one or more processors such as one or more CPUs, DSPs, NPUs, NSPs, microcontrollers, ASICs, FPGAs, programmable logic devices, discrete gates or transistor logic components, discrete hardware components, etc., any combination thereof, and/or other component or system) of the computing device or apparatus. In some aspects, the process 1100 can be performed by a UE or other user communication device and/or user computing system, such as a user communication device or user computing system implementing or including the SOC 100 of FIG. 1A, the user device computing system 170 and/or the user computing device 150 of FIG. 1B, the first device 202 and/or second device 206 of FIG. 2, the user computing device 302 of FIG. 3, the call initiator device 402 and/or call receiver device 406 of FIG. 4, the call initiator device 502 and/or the call receiver device 506 of FIG. 5, the first device 802 and/or the second device 806 of FIG. 8, the mobile computing device 812 of FIG. 8, the user computing device 814 of FIG. 8, the head mounted device (HMD) 816 of FIG. 8, the first device 902 and/or the second device 906 of FIG. 9, the mobile computing device 912 of FIG. 9, the user computing device 914 of FIG. 9, the head mounted device (HMD) 916 of FIG. 9, the first device 1002 and/or the second device 1006 of FIG. 10, the mobile computing device 1012 of FIG. 10, the user computing device 1014 of FIG. 10, the head mounted device (HMD) 1016 of FIG. 10, and/or the wearable computing device 1018 of FIG. 10, etc., among various others.

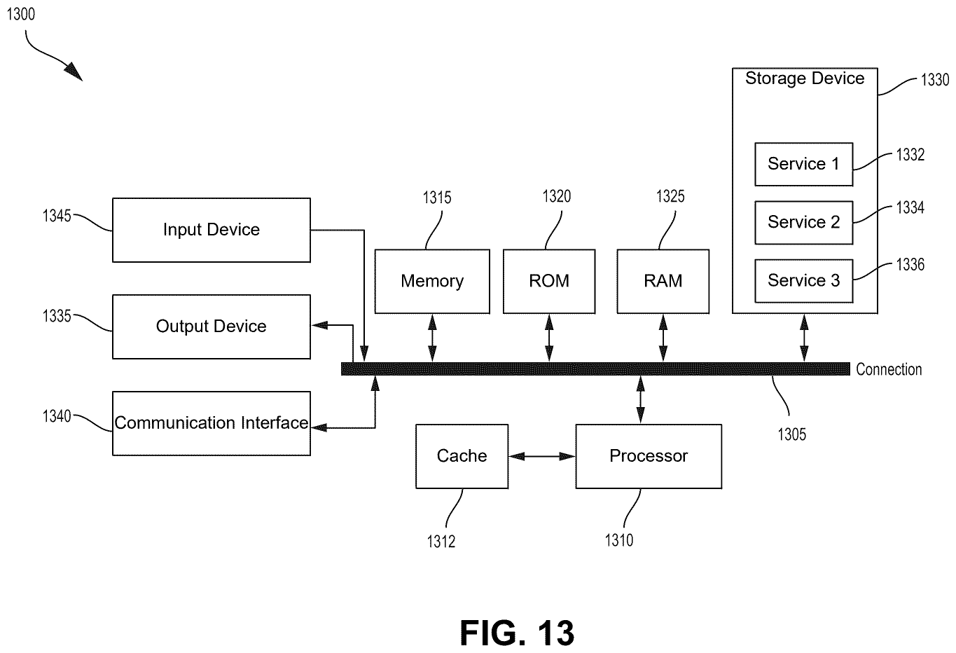

In some aspects, the process 1100 can be performed by a user computing device and/or a user communication device (e.g., a mobile device such as a mobile phone, a network-connected wearable such as a watch, an extended reality device such as a virtual reality (VR) device or augmented reality (AR) device, a vehicle or component or system of a vehicle, or other type of UE) or other type of network entity. The process 1100 may be performed by a component or system (e.g., a chipset) of the user device. The operations of the process 1100 may be implemented as software components that are executed and run on one or more processors (e.g., processor 1310 of FIG. 13 or other processor(s)). Further, the transmission and reception of signals by the user device in the process 1100 may be enabled, for example, by one or more antennas and/or one or more transceivers.

At block 1102, the computing device (or component thereof) can receive, from a second device, a request to initiate a communication session between the second device and a first device wherein the request includes caller attestation information corresponding to a user of the second device, the caller attestation information determined by the second device based on information obtained from one or more sensors included in the second device.

For example, the second device can be a call initiator device and the first device (e.g., the computing device performing process 1100) can be a call recipient device. In some cases, the request can be the same as or similar to one or more of the requests 232 of FIG. 2, 310 of FIG. 3, 412 of FIG. 4, 512 of FIG. 5, etc. In some examples, the caller attestation information can correspond to a user of the call initiator device (e.g., the second device).

In some cases, the caller attestation information includes one or more attestation features generated by the second device. For example, the one or more attestation features can be the same as or similar to one or more of the attestation features 620-1, 620-2, . . . , 620-N of FIG. 6, etc. In some examples, the one or more attestation features are generated in association with the request to initiate the communication session. For example, the one or more attestation features can be generated as the attestation feature generation 514 of FIG. 5, etc. In some cases, the caller attestation information is determined based on one or more attestation features obtained by the second device before the request to initiate the communication session. In some examples, the caller attestation information is determined by the second device based on information obtained from one or more sensors included in the second device.

In some cases, the caller attestation information is determined by the second device without communication between the second device and one or more additional devices different from the first device. In some examples, the caller attestation information includes one or more attestation features included in a configured plurality of attestation features. In some cases, the caller attestation information is indicative of one or more detected attestation features detected by the second device, the one or more detected attestation features included in a configured plurality of attestation features. For example, the caller attestation information can be further indicative of one or more additional attestation features included in the configured plurality of attestation features and not detected by the second device. In some cases, each detected attestation feature of the one or more detected attestation features corresponds to one or more of a gesture performed by the user of the second device, a movement of the user of the second device, or a keyword spoken by the user of the second device.

In some examples, the caller attestation information comprises an attestation bitmask including a plurality of attestation bits, and wherein a first value of a respective attestation bit of the plurality of attestation bits indicates a corresponding attestation feature was not detected for the user of the second device and a second value of the respective attestation bit indicates the corresponding attestation feature was detected for the user of the second device.

For example, the attestation bitmask may be the same as or similar to the attestation bitmask 640 of FIG. 6, 740 of FIG. 7, 840 of FIG. 8, 940 of FIG. 9, 1040 of FIG. 10, etc. In some cases, the attestation bitmask is based on sensor data obtained by the second device, the sensor data corresponding to the user of the second device. In some cases, determining the authentication result comprises comparing the attestation bitmask to the authentication configuration information associated with the user of the first device.

At block 1104, the computing device (or component thereof) can determine an authentication result corresponding to the request to initiate the communication session, the authentication result determined based on comparing the caller attestation information included in the request with authentication configuration information associated with a user of the first device. For example, the authentication result can be the unsuccessful authentication result 420 of FIG. 4, the successful authentication result 520 of FIG. 5, the authentication result 720 of FIG. 7, etc.

In some cases, the computing device (or component thereof) can determine an unsuccessful authentication result corresponding to the caller attestation information not including one or more required attestation features indicated by the authentication configuration information. The computing device (or component thereof) can transmit a message from the first device to the second device indicative of the one or more required attestation features not included in the caller attestation information corresponding to the unsuccessful authentication result. In some cases, the computing device (or component thereof) can determine a successful secondary authentication result of the user of the second device, wherein the successful secondary authentication result is not based on the caller attestation information. The computing device (or component thereof) can transmit the message from the first device to the second device in response to the successful secondary authentication result.

In some cases, an attestation bitmask may be the same as or similar to the attestation bitmask 640 of FIG. 6, 740 of FIG. 7, 840 of FIG. 8, 940 of FIG. 9, 1040 of FIG. 10, etc. In some cases, the attestation bitmask is based on sensor data obtained by the second device, the sensor data corresponding to the user of the second device. In some cases, determining the authentication result comprises comparing the attestation bitmask to the authentication configuration information associated with the user of the first device.

In some examples, the authentication configuration information is indicative of one or more required attestation features, and a successful authentication result is determined based on the attestation bitmask including a corresponding attestation bit equal to the second value for each of the one or more required attestation features. In some cases, the authentication configuration information is indicative of a threshold number of attestation features, and a successful authentication result is determined based on the attestation bitmask including a quantity of respective attestation bits equal to the second value that is greater than or equal to the threshold number.

In some cases, the computing device (or component thereof) is further configured to determine an unsuccessful authentication result based on the attestation bitmask including a number of respective attestation bits with the second value that is less than a threshold indicated by the authentication configuration information, or to determine the unsuccessful authentication result based on the attestation bitmask including the first value for a respective attestation bit corresponding to a required attestation feature indicated by the authentication configuration information.

At block 1106, the computing device (or component thereof) can configure the communication session between the second device and the first device based on the authentication result, wherein configuring the communication session includes processing one or more inputs corresponding to biometric information of the user of the first device based on the authentication result. For example, the one or more inputs can include one or more of: audio data obtained using the first device, the audio data indicative of biometric information corresponding to a voice of the user of the first device, or image data obtained using the first device, the image data indicative of biometric information corresponding to anatomy of the user of the first device. Configuring the communication session based on a successful authentication result can include obtaining the one or more inputs corresponding to biometric information of the user of the first device by one or more input devices of the first device, transmitting the one or more inputs to the second device during the communication session, wherein the communication session includes the biometric information of the user of the first device.

In some cases, configuring the communication session based on an unsuccessful authentication result can include obtaining the one or more inputs corresponding to biometric information of the user of the first device by one or more input devices of the first device, and processing the one or more inputs to generate one or more obfuscated inputs, where the one or more obfuscated inputs do not include the biometric information of the user of the first device. Configuring the communication session based on the unsuccessful authentication result can further include transmitting the one or more obfuscated inputs to the second device during the communication session, where the communication session does not include the biometric information of the user of the first device.

In some cases, the one or more inputs comprise audiovisual data of the user of the first device, the audiovisual data obtained from one or more sensors of the first device and corresponding to the communication session, and the one or more obfuscated inputs comprise one or more degraded representations or masked representations of the audiovisual data with the biometric information removed.

In some cases, the computing device (or component thereof) can generate the one or more obfuscated inputs based on processing the one or more inputs using a quality reduction codec. The one or more inputs corresponding to the biometric information can be associated with a first quality level, and the one or more obfuscated inputs can be associated with a second quality level, the second quality level less than the first quality level.

In some cases, the quality reduction codec is configured to reduce one or more of an original resolution associated with the one or more inputs, or an original sampling rate associated with the one or more inputs. In some examples, the one or more inputs corresponding to the biometric information comprise image data of a face of the user of the first device, and processing the one or more inputs using the quality reduction codec corresponds to one or more of blurring a portion of the image data corresponding to the face of the user of the first device, or occluding the portion of the image data corresponding to the face of the user of the first device. In some cases, the one or more inputs corresponding to the biometric information comprise audio data of a voice of the user of the first device, and processing the one or more inputs using the quality reduction codec corresponds to applying one or more audio distortions to the audio data. In some examples, the authentication configuration information includes one or more of: one or more authentication requirements associated with the user of the first device, or one or more authentication criteria to determine a corresponding authentication result for a received caller attestation information.

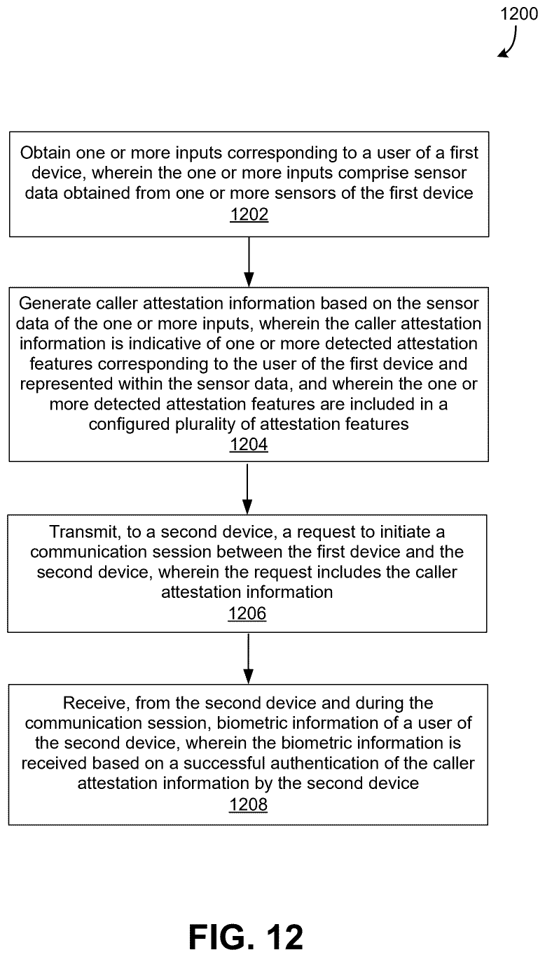

FIG. 12 is a flowchart diagram illustrating an example of a process 1200 for authentication and/or attestation of communications between user devices. In some examples, the process 1200 can be performed by a device associated with a call initiator (e.g., calling party, call initiator, calling party, etc.). In some examples, the process 1200 can be performed by a computing device or apparatus or a component or system (e.g., one or more chipsets, one or more processors such as one or more CPUs, DSPs, NPUs, NSPs, microcontrollers, ASICs, FPGAs, programmable logic devices, discrete gates or transistor logic components, discrete hardware components, etc., any combination thereof, and/or other component or system) of the computing device or apparatus. In some aspects, the process 1200 can be performed by a UE or other user communication device and/or user computing system, such as a user communication device or user computing system implementing or including the SOC 100 of FIG. 1A, the user device computing system 170 and/or the user computing device 150 of FIG. 1B, the first device 202 and/or second device 206 of FIG. 2, the user computing device 302 of FIG. 3, the call initiator device 402 and/or call receiver device 406 of FIG. 4, the call initiator device 502 and/or the call receiver device 506 of FIG. 5, the first device 802 and/or the second device 806 of FIG. 8, the mobile computing device 812 of FIG. 8, the user computing device 814 of FIG. 8, the head mounted device (HMD) 816 of FIG. 8, the first device 902 and/or the second device 906 of FIG. 9, the mobile computing device 912 of FIG. 9, the user computing device 914 of FIG. 9, the head mounted device (HMD) 916 of FIG. 9, the first device 1002 and/or the second device 1006 of FIG. 10, the mobile computing device 1012 of FIG. 10, the user computing device 1014 of FIG. 10, the head mounted device (HMD) 1016 of FIG. 10, and/or the wearable computing device 1018 of FIG. 10, etc., among various others.

In some aspects, the process 1200 can be performed by a user computing device and/or a user communication device (e.g., a mobile device such as a mobile phone, a network-connected wearable such as a watch, an extended reality device such as a virtual reality (VR) device or augmented reality (AR) device, a vehicle or component or system of a vehicle, or other type of UE) or other type of network entity. The process 1200 may be performed by a component or system (e.g., a chipset) of the user device. The operations of the process 1200 may be implemented as software components that are executed and run on one or more processors (e.g., processor 1310 of FIG. 13 or other processor(s)). Further, the transmission and reception of signals by the user device in the process 1200 may be enabled, for example, by one or more antennas and/or one or more transceivers.

At block 1202, the computing device (or component thereof) can obtain one or more inputs corresponding to a user of a first device, wherein the one or more inputs comprise sensor data obtained from one or more sensors of the first device. For example, the first device can be a call initiator device, and the one or more inputs can be inputs corresponding to a call initiator user. The call initiator device and call initiator user can be associated with transmitting a call initiation request to a second device (e.g., a call recipient device associated with a call recipient user). For example, the call initiator device can transmit a request to initiate a communication session between the call initiator device (e.g., first device) and the call recipient device (e.g., second device). In some cases, the request can be the same as or similar to one or more of the requests 232 of FIG. 2, 310 of FIG. 3, 412 of FIG. 4, 512 of FIG. 5, etc.

At block 1204, the computing device (or component thereof) can generate caller attestation information based on the sensor data of the one or more inputs, wherein the caller attestation information is indicative of one or more detected attestation features corresponding to the user of the first device and represented within the sensor data, and wherein the one or more detected attestation features are included in a configured plurality of attestation features.

For example, the one or more attestation features can be the same as or similar to one or more of the attestation features 620-1, 620-2, . . . , 620-N of FIG. 6, etc. In some examples, the one or more attestation features are generated in association with the request to initiate the communication session. For example, the one or more attestation features can be generated as the attestation feature generation 514 of FIG. 5, etc. In some cases, the caller attestation information includes one or more attestation features obtained by the first device before the request to initiate the communication session. In some examples, the caller attestation information is determined by the first device based on information obtained from one or more sensors included in the first device.

In some cases, the caller attestation information is determined by the first device without communication between the first device and one or more additional devices different from the first device. In some examples, the caller attestation information includes one or more attestation features included in a configured plurality of attestation features. In some cases, the caller attestation information is indicative of one or more detected attestation features detected by the first device, the one or more detected attestation features included in a configured plurality of attestation features. For example, the caller attestation information can be further indicative of one or more additional attestation features included in the configured plurality of attestation features and not detected by the first device. In some cases, each detected attestation feature of the one or more detected attestation features corresponds to one or more of a gesture performed by the user of the first device, a movement of the user of the first device, or a keyword spoken by the user of the first device.

In some examples, the caller attestation information comprises an attestation bitmask including a plurality of attestation bits, and wherein a first value of a respective attestation bit of the plurality of attestation bits indicates a corresponding attestation feature was not detected for the user of the first device and a second value of the respective attestation bit indicates the corresponding attestation feature was detected for the user of the first device. For example, the attestation bitmask may be the same as or similar to the attestation bitmask 640 of FIG. 6, 740 of FIG. 7, 840 of FIG. 8, 940 of FIG. 9, 1040 of FIG. 10, etc. In some cases, the attestation bitmask is based on sensor data obtained by the first device, the sensor data corresponding to the user of the first device. In some cases, determining an authentication result comprises comparing the attestation bitmask to an authentication configuration information associated with the user of the second device.

At block 1206, the computing device (or component thereof) can transmit, to a second device, a request to initiate a communication session between the first device and the second device, wherein the request includes the caller attestation information. At block 1208, the computing device (or component thereof) can transmit, to a second device, a request to initiate a communication session between the first device and the second device, wherein the request includes the caller attestation information.

In some examples, the processes described herein (e.g., process 1100, process 1200, and/or other process described herein) may be performed by a computing device or apparatus which may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the WiFi (802.11x) standards, data according to the Bluetooth™ standard, data according to the Internet Protocol (IP) standard, and/or other types of data.

The components of the computing device may be implemented in circuitry. For example, the components may include and/or may be implemented using electronic circuits or other electronic hardware, which may include one or more programmable electronic circuits (e.g., microprocessors, graphics processing units (GPUs), digital signal processors (DSPs), central processing units (CPUs), and/or other suitable electronic circuits), and/or may include and/or be implemented using computer software, firmware, or any combination thereof, to perform the various operations described herein.

The process 1100 and/or the process 1200 are illustrated as logical flow diagrams, the operation of which represents a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

Additionally, the process 1100, process 1200, and/or other process described herein, may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 13 is a diagram illustrating an example of a system for implementing certain aspects of the present technology. In particular, FIG. 13 illustrates an example of computing system 1300, which may be for example any computing device making up internal computing system, a remote computing system, a camera, or any component thereof in which the components of the system are in communication with each other using connection 1305. Connection 1305 may be a physical connection using a bus, or a direct connection into processor 1310, such as in a chipset architecture. Connection 1305 may also be a virtual connection, networked connection, or logical connection.

In some aspects, computing system 1300 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example system 1300 includes at least one processing unit (CPU or processor) 1310 and connection 1305 that communicatively couples various system components including system memory 1315, such as read-only memory (ROM) 1320 and random access memory (RAM) 1325 to processor 1310. Computing system 1300 may include a cache 1312 of high-speed memory connected directly with, in close proximity to, or integrated as part of processor 1310.

Processor 1310 may include any general-purpose processor and a hardware service or software service, such as services 1332, 1334, and 1336 stored in storage device 1330, configured to control processor 1310 as well as a special-purpose processor where software instructions are incorporated into the actual processor design. Processor 1310 may essentially be a completely self-contained computing system, containing multiple cores or processors, a bus, memory controller, cache, etc. A multi-core processor may be symmetric or asymmetric.

To enable user interaction, computing system 1300 includes an input device 1345, which may represent any number of input mechanisms, such as a microphone for speech, a touch-sensitive screen for gesture or graphical input, keyboard, mouse, motion input, speech, etc. Computing system 1300 may also include output device 1335, which may be one or more of a number of output mechanisms. In some instances, multimodal systems may enable a user to provide multiple types of input/output to communicate with computing system 1300.

Computing system 1300 may include communications interface 1340, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1340 may also include one or more Global Navigation Satellite System (GNSS) receivers or transceivers that are used to determine a location of the computing system 1300 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1330 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1330 may include software services, servers, services, etc., that when the code that defines such software is executed by the processor 1310, it causes the system to perform a function. In some aspects, a hardware service that performs a particular function may include the software component stored in a computer-readable medium in connection with the necessary hardware components, such as processor 1310, connection 1305, output device 1335, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, application specific integrated circuits (ASICs), field programmable gate arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one”and “one or more”are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

### Aspect 1

A method for communications by a first device, the method comprising: receiving, from a second device, a request to initiate a communication session between the second device and the first device wherein the request includes caller attestation information corresponding to a user of the second device, the caller attestation information determined by the second device based on information obtained from one or more sensors included in the second device; determining an authentication result corresponding to the request to initiate the communication session, the authentication result determined based on comparing the caller attestation information included in the request with authentication configuration information associated with a user of the first device; and configuring the communication session between the second device and the first device based on the authentication result, wherein configuring the communication session includes processing one or more inputs corresponding to biometric information of the user of the first device based on the authentication result.

### Aspect 2

The method of Aspect 1, wherein the one or more inputs include audio data obtained using the first device, the audio data indicative of biometric information corresponding to a voice of the user of the first device.

### Aspect 3

The method of any of Aspects 1 to 2, wherein the one or more inputs include image data obtained using the first device, the image data indicative of biometric information corresponding to anatomy of the user of the first device.

### Aspect 4

The method of any of Aspects 1 to 3, wherein configuring the communication session based on a successful authentication result includes: obtaining the one or more inputs corresponding to biometric information of the user of the first device by one or more input devices of the first device; and transmitting the one or more inputs to the second device during the communication session, wherein the communication session includes the biometric information of the user of the first device.

### Aspect 5

The method of any of Aspects 1 to 4, wherein configuring the communication session based on an unsuccessful authentication result includes: obtaining the one or more inputs corresponding to biometric information of the user of the first device by one or more input devices of the first device; processing the one or more inputs to generate one or more obfuscated inputs, wherein the one or more obfuscated inputs do not include the biometric information of the user of the first device; and transmitting the one or more obfuscated inputs to the second device during the communication session, wherein the communication session does not include the biometric information of the user of the first device.

### Aspect 6

The method of Aspect 5, further comprising generating the one or more obfuscated inputs based on processing the one or more inputs using a quality reduction codec.

### Aspect 7

The method of Aspect 6, wherein: the one or more inputs corresponding to the biometric information are associated with a first quality level; and the one or more obfuscated inputs are associated with a second quality level, the second quality level less than the first quality level.

### Aspect 8

The method of any of Aspects 6 to 7, wherein the quality reduction codec is configured to reduce one or more of an original resolution associated with the one or more inputs, or an original sampling rate associated with the one or more inputs.

### Aspect 9

The method of any of Aspects 6 to 8, wherein: the one or more inputs corresponding to the biometric information comprise image data of a face of the user of the first device; and processing the one or more inputs using the quality reduction codec corresponds to one or more of blurring a portion of the image data corresponding to the face of the user of the first device, or occluding the portion of the image data corresponding to the face of the user of the first device.

### Aspect 10

The method of any of Aspects 6 to 9, wherein: the one or more inputs corresponding to the biometric information comprise audio data of a voice of the user of the first device; and processing the one or more inputs using the quality reduction codec corresponds to applying one or more audio distortions to the audio data.

### Aspect 11

The method of any of Aspects 5 to 10, wherein: the one or more inputs comprise audiovisual data of the user of the first device, the audiovisual data obtained from one or more sensors of the first device and corresponding to the communication session; and the one or more obfuscated inputs comprise one or more degraded representations or masked representations of the audiovisual data with the biometric information removed.

### Aspect 12

The method of any of Aspects 1 to 11, wherein the caller attestation information includes one or more attestation features generated by the second device.

### Aspect 13

The method of Aspect 12, wherein the one or more attestation features are generated in association with the request to initiate the communication session.

### Aspect 14

The method of any of Aspects 1 to 13, wherein the caller attestation information is determined based on one or more attestation features obtained by the second device before the request to initiate the communication session.

### Aspect 15

The method of any of Aspects 1 to 14, wherein the caller attestation information is determined by the second device based on one or more biometric inputs corresponding to the user of the second device, the one or more biometric inputs corresponding to the user of the second device included in the information obtained from the one or more sensors included in the second device.

### Aspect 16

The method of Aspect 15, wherein the caller attestation information is determined by the second device without communication between the second device and one or more additional devices different from the first device.

### Aspect 17

The method of any of Aspects 1 to 16, wherein the caller attestation information includes one or more attestation features included in a configured plurality of attestation features.

### Aspect 18

The method of any of Aspects 1 to 17, wherein the caller attestation information is indicative of one or more detected attestation features detected by the second device, the one or more detected attestation features included in a configured plurality of attestation features.

### Aspect 19

The method of Aspect 18, wherein the caller attestation information is further indicative of one or more additional attestation features included in the configured plurality of attestation features and not detected by the second device.

### Aspect 20

The method of any of Aspects 18 to 19, wherein each detected attestation feature of the one or more detected attestation features corresponds to one or more of a gesture performed by the user of the second device, a movement of the user of the second device, or a keyword spoken by the user of the second device.

### Aspect 21

The method of any of Aspects 1 to 20, wherein the caller attestation information comprises an attestation bitmask including a plurality of attestation bits, and wherein a first value of a respective attestation bit of the plurality of attestation bits indicates a corresponding attestation feature was not detected for the user of the second device and a second value of the respective attestation bit indicates the corresponding attestation feature was detected for the user of the second device.

### Aspect 22

The method of Aspect 21, wherein the attestation bitmask is based on sensor data obtained by the second device, the sensor data corresponding to the user of the second device.

### Aspect 23

The method of any of Aspects 21 to 22, wherein determining the authentication result comprises comparing the attestation bitmask to the authentication configuration information associated with the user of the first device.

### Aspect 24

The method of Aspect 23, wherein: the authentication configuration information is indicative of one or more required attestation features; and a successful authentication result is determined based on the attestation bitmask including a corresponding attestation bit equal to the second value for each of the one or more required attestation features.

### Aspect 25

The method of Aspect 24, wherein: the authentication configuration information is indicative of a threshold number of attestation features; and a successful authentication result is determined based on the attestation bitmask including a quantity of respective attestation bits equal to the second value that is greater than or equal to the threshold number.

### Aspect 26

The method of any of Aspects 23 to 25, further comprising: determining an unsuccessful authentication result based on the attestation bitmask including a number of respective attestation bits with the second value that is less than a threshold indicated by the authentication configuration information; or determining the unsuccessful authentication result based on the attestation bitmask including the first value for a respective attestation bit corresponding to a required attestation feature indicated by the authentication configuration information.

### Aspect 27

The method of any of Aspects 1 to 26, wherein the authentication configuration information comprises one or more authentication requirements associated with the user of the first device.

### Aspect 28

The method of any of Aspects 1 to 27, wherein the authentication configuration information comprises one or more authentication criteria to determine a corresponding authentication result for a received caller attestation information.

### Aspect 29

The method of any of Aspects 1 to 28, wherein the authentication configuration information is indicative of one or more authentication requirements to determine a successful authentication result for a received caller attestation information.

### Aspect 30

The method of any of Aspects 1 to 29, further comprising: determining an unsuccessful authentication result corresponding to the caller attestation information not including one or more required attestation features indicated by the authentication configuration information; and transmitting a message from the first device to the second device indicative of the one or more required attestation features not included in the caller attestation information corresponding to the unsuccessful authentication result.

### Aspect 31

The method of Aspect 30, further comprising: determining a successful secondary authentication result of the user of the second device, wherein the successful secondary authentication result is not based on the caller attestation information; and transmitting the message from the first device to the second device in response to the successful secondary authentication result.

### Aspect 32

An apparatus of a first device for communications, comprising: a memory; and a processor coupled to the memory, wherein the processor is configured to: receive, from a second device, a request to initiate a communication session between the second device and the first device wherein the request includes caller attestation information corresponding to a user of the second device, the caller attestation information determined by the second device based on information obtained from one or more sensors included in the second device; determine an authentication result corresponding to the request to initiate the communication session, the authentication result determined based on comparing the caller attestation information included in the request with authentication configuration information associated with a user of the first device; and configure the communication session between the second device and the first device based on the authentication result, wherein configuring the communication session includes processing one or more inputs corresponding to biometric information of the user of the first device based on the authentication result.

### Aspect 33

The apparatus of Aspect 32, wherein the one or more inputs include audio data obtained using the first device, the audio data indicative of biometric information corresponding to a voice of the user of the first device.

### Aspect 34

The apparatus of any of Aspects 32 to 33, wherein the one or more inputs include image data obtained using the first device, the image data indicative of biometric information corresponding to anatomy of the user of the first device.

### Aspect 35

The apparatus of any of Aspects 32 to 34, wherein, to configure the communication session based on a successful authentication result, the processor is configured to: obtain the one or more inputs corresponding to biometric information of the user of the first device by one or more input devices of the first device; and transmit the one or more inputs to the second device during the communication session, wherein the communication session includes the biometric information of the user of the first device.

### Aspect 36

The apparatus of any of Aspects 32 to 35, wherein, to configure the communication session based on an unsuccessful authentication result, the processor is configured to: obtain the one or more inputs corresponding to biometric information of the user of the first device by one or more input devices of the first device; process the one or more inputs to generate one or more obfuscated inputs, wherein the one or more obfuscated inputs do not include the biometric information of the user of the first device; and transmit the one or more obfuscated inputs to the second device during the communication session, wherein the communication session does not include the biometric information of the user of the first device.

### Aspect 37

The apparatus of Aspect 36, wherein the processor is further configured to generate the one or more obfuscated inputs based on processing the one or more inputs using a quality reduction codec.

### Aspect 38

The apparatus of Aspect 37, wherein: the one or more inputs corresponding to the biometric information are associated with a first quality level; and the one or more obfuscated inputs are associated with a second quality level, the second quality level less than the first quality level.

### Aspect 39

The apparatus of any of Aspects 37 to 38, wherein the quality reduction codec is configured to reduce one or more of an original resolution associated with the one or more inputs, or an original sampling rate associated with the one or more inputs.

### Aspect 40

The apparatus of any of Aspects 37 to 39, wherein: the one or more inputs corresponding to the biometric information comprise image data of a face of the user of the first device; and to process the one or more inputs using the quality reduction codec, the processor is configured to perform one or more of blurring a portion of the image data corresponding to the face of the user of the first device, or occluding the portion of the image data corresponding to the face of the user of the first device.

### Aspect 41

The apparatus of any of Aspects 37 to 40, wherein: the one or more inputs corresponding to the biometric information comprise audio data of a voice of the user of the first device; and processing the one or more inputs using the quality reduction codec corresponds to applying one or more audio distortions to the audio data.

### Aspect 42

The apparatus of any of Aspects 36 to 41, wherein: the one or more inputs comprise audiovisual data of the user of the first device, the audiovisual data obtained from one or more sensors of the first device and corresponding to the communication session; and the one or more obfuscated inputs comprise one or more degraded representations or masked representations of the audiovisual data with the biometric information removed.

### Aspect 43

The apparatus of any of Aspects 32 to 42, wherein the caller attestation information includes one or more attestation features generated by the second device.

### Aspect 44

The apparatus of Aspect 43, wherein the one or more attestation features are generated in association with the request to initiate the communication session.

### Aspect 45

The apparatus of any of Aspects 32 to 44, wherein the caller attestation information is determined based on one or more attestation features obtained by the second device before the request to initiate the communication session.

### Aspect 46

The apparatus of any of Aspects 32 to 45, wherein the caller attestation information is determined by the second device based on one or more biometric inputs corresponding to the user of the second device, the one or more biometric inputs corresponding to the user of the second device included in the information obtained from the one or more sensors included in the second device.

### Aspect 47

The apparatus of Aspect 46, wherein the caller attestation information is determined by the second device without communication between the second device and one or more additional devices different from the first device.

### Aspect 48

The apparatus of any of Aspects 32 to 47, wherein the caller attestation information includes one or more attestation features included in a configured plurality of attestation features.

### Aspect 49

The apparatus of any of Aspects 32 to 48, wherein the caller attestation information is indicative of one or more detected attestation features detected by the second device, the one or more detected attestation features included in a configured plurality of attestation features.

### Aspect 50

The apparatus of Aspect 49, wherein the caller attestation information is further indicative of one or more additional attestation features included in the configured plurality of attestation features and not detected by the second device.

### Aspect 51

The apparatus of any of Aspects 49 to 50, wherein each detected attestation feature of the one or more detected attestation features corresponds to one or more of a gesture performed by the user of the second device, a movement of the user of the second device, or a keyword spoken by the user of the second device.

### Aspect 52

The apparatus of any of Aspects 32 to 51, wherein the caller attestation information comprises an attestation bitmask including a plurality of attestation bits, and wherein a first value of a respective attestation bit of the plurality of attestation bits indicates a corresponding attestation feature was not detected for the user of the second device and a second value of the respective attestation bit indicates the corresponding attestation feature was detected for the user of the second device.

### Aspect 53

The apparatus of Aspect 52, wherein the attestation bitmask is based on sensor data obtained by the second device, the sensor data corresponding to the user of the second device.

### Aspect 54

The apparatus of any of Aspects 52 to 53, wherein, to determine the authentication result, the processor is configured to compare the attestation bitmask to the authentication configuration information associated with the user of the first device.

### Aspect 55

The apparatus of Aspect 54, wherein: the authentication configuration information is indicative of one or more required attestation features; and a successful authentication result is determined based on the attestation bitmask including a corresponding attestation bit equal to the second value for each of the one or more required attestation features.

### Aspect 56

The apparatus of Aspect 55, wherein: the authentication configuration information is indicative of a threshold number of attestation features; and a successful authentication result is determined based on the attestation bitmask including a quantity of respective attestation bits equal to the second value that is greater than or equal to the threshold number.

### Aspect 57

The apparatus of any of Aspects 54 to 56, wherein the processor is further configured to: determine an unsuccessful authentication result based on the attestation bitmask including a number of respective attestation bits with the second value that is less than a threshold indicated by the authentication configuration information; or determine the unsuccessful authentication result based on the attestation bitmask including the first value for a respective attestation bit corresponding to a required attestation feature indicated by the authentication configuration information.

### Aspect 58

The apparatus of any of Aspects 32 to 57, wherein the authentication configuration information comprises one or more authentication requirements associated with the user of the first device.

### Aspect 59

The apparatus of any of Aspects 32 to 58, wherein the authentication configuration information comprises one or more authentication criteria to determine a corresponding authentication result for a received caller attestation information.

### Aspect 60

The apparatus of any of Aspects 32 to 59, wherein the authentication configuration information is indicative of one or more authentication requirements to determine a successful authentication result for a received caller attestation information.

### Aspect 61

The apparatus of any of Aspects 32 to 60, wherein the processor is further configured to: determine an unsuccessful authentication result corresponding to the caller attestation information not including one or more required attestation features indicated by the authentication configuration information; and transmit a message from the first device to the second device indicative of the one or more required attestation features not included in the caller attestation information corresponding to the unsuccessful authentication result.

### Aspect 62

The apparatus of Aspect 61, wherein the processor is further configured to: determine a successful secondary authentication result of the user of the second device, wherein the successful secondary authentication result is not based on the caller attestation information; and transmit the message from the first device to the second device in response to the successful secondary authentication result.

### Aspect 63

A method comprising: obtaining one or more inputs corresponding to a user of a first device, wherein the one or more inputs comprise sensor data obtained from one or more sensors of the first device; generating caller attestation information based on the sensor data of the one or more inputs, wherein the caller attestation information is indicative of one or more detected attestation features corresponding to the user of the first device and represented within the sensor data, and wherein the one or more detected attestation features are included in a configured plurality of attestation features; transmitting, to a second device, a request to initiate a communication session between the first device and the second device, wherein the request includes the caller attestation information; and receiving, from the second device and during the communication session, biometric information of a user of the second device, wherein the biometric information is received based on a successful authentication of the caller attestation information by the second device.

### Aspect 64

The method of Aspect 63, wherein the one or more inputs include audio data obtained using the first device, the audio data indicative of biometric information corresponding to a voice of the user of the first device.

### Aspect 65

The method of any of Aspects 63 to 64, wherein the one or more inputs include image data obtained using the first device, the image data indicative of biometric information corresponding to anatomy of the user of the first device.

### Aspect 66

The method of any of Aspects 63 to 65, further comprising: receiving, from the second device and during the communication session, one or more obfuscated inputs, wherein the one or more obfuscated inputs do not include the biometric information of the user of the second device, and wherein the one or more obfuscated inputs are received based on an unsuccessful authentication of the caller attestation information by the second device.

### Aspect 67

The method of Aspect 66, wherein the one or more obfuscated inputs are associated with a quality reduction codec of the second device.

### Aspect 68

The method of Aspect 67, wherein the quality reduction codec is configured to reduce one or more of an original resolution associated with the one or more inputs, or an original sampling rate associated with the one or more inputs.

### Aspect 69

The method of any of Aspects 67 to 68, wherein: the biometric information comprises image data of a face of the user of the second device; and the one or more obfuscated inputs are generated based on using the quality reduction codec to blur a portion of the image data corresponding to the face of the user of the second device, or to occlude the portion of the image data corresponding to the face of the user of the second device.

### Aspect 70

The method of any of Aspects 67 to 69, wherein: the biometric information comprises audio data of a voice of the user of the second device; and the one or more obfuscated inputs are generated based on using the quality reduction codec to apply one or more audio distortions to the audio data.

### Aspect 71

The method of any of Aspects 66 to 70, wherein: the biometric information comprises audiovisual data of the user of the second device, the audiovisual data obtained from one or more sensors of the second device and corresponding to the communication session; and the one or more obfuscated inputs comprise one or more degraded representations or masked representations of the audiovisual data with the biometric information removed.

### Aspect 72

The method of any of Aspects 63 to 71, wherein the caller attestation information includes one or more attestation features generated by the first device.

### Aspect 73

The method of Aspect 72, wherein the one or more attestation features are generated in association with the request to initiate the communication session.

### Aspect 74

The method of any of Aspects 63 to 73, wherein the caller attestation information includes one or more attestation features obtained by the first device before the request to initiate the communication session.

### Aspect 75

The method of any of Aspects 63 to 74, wherein the caller attestation information is determined by the first device based on information obtained from one or more sensors included in the first device.

### Aspect 76

The method of Aspect 75, wherein the caller attestation information is determined by the first device without communication between the first device and one or more additional devices including the second device.

### Aspect 77

The method of any of Aspects 63 to 76, wherein the caller attestation information includes one or more attestation features included in a configured plurality of attestation features.

### Aspect 78

The method of any of Aspects 63 to 77, wherein the caller attestation information is indicative of one or more detected attestation features detected by the first device, the one or more detected attestation features included in a configured plurality of attestation features.

### Aspect 79

The method of Aspect 78, wherein the caller attestation information is further indicative of one or more additional attestation features included in the configured plurality of attestation features and not detected by the first device.

### Aspect 80

The method of any of Aspects 78 to 79, wherein each detected attestation feature of the one or more detected attestation features corresponds to one or more of a gesture performed by the user of the first device, a movement of the user of the first device, or a keyword spoken by the user of the first device.

### Aspect 81

The method of any of Aspects 63 to 80, wherein the caller attestation information comprises an attestation bitmask including a plurality of attestation bits, and wherein a first value of a respective attestation bit of the plurality of attestation bits indicates a corresponding attestation feature was not detected for the user of the first device and a second value of the respective attestation bit indicates the corresponding attestation feature was detected for the user of the first device.

### Aspect 82

The method of Aspect 81, wherein the attestation bitmask is based on sensor data obtained by the first device, the sensor data corresponding to the user of the first device.

### Aspect 83

The method of any of Aspects 81 to 82, wherein determining the authentication result comprises comparing the attestation bitmask to the authentication configuration information associated with the user of the second device.

### Aspect 84

The method of Aspect 83, wherein: the authentication configuration information is indicative of one or more required attestation features; and a successful authentication result is determined based on the attestation bitmask including a corresponding attestation bit equal to the second value for each of the one or more required attestation features.

### Aspect 85

The method of Aspect 84, wherein: the authentication configuration information is indicative of a threshold number of attestation features; and a successful authentication result is determined based on the attestation bitmask including a quantity of respective attestation bits equal to the second value that is greater than or equal to the threshold number.

### Aspect 86

The method of any of Aspects 83 to 85, further comprising: determining an unsuccessful authentication result based on the attestation bitmask including a number of respective attestation bits with the second value that is less than a threshold indicated by the authentication configuration information; or determining the unsuccessful authentication result based on the attestation bitmask including the first value for a respective attestation bit corresponding to a required attestation feature indicated by the authentication configuration information.

### Aspect 87

The method of any of Aspects 63 to 86, wherein the authentication configuration information comprises one or more authentication requirements associated with the user of the second device.

### Aspect 88

The method of any of Aspects 63 to 87, wherein the authentication configuration information comprises one or more authentication criteria to determine a corresponding authentication result for a received caller attestation information.

### Aspect 89

The method of any of Aspects 63 to 88, wherein the authentication configuration information is indicative of one or more authentication requirements to determine a successful authentication result for a received caller attestation information.

### Aspect 90

The method of any of Aspects 63 to 89, further comprising: determining an unsuccessful authentication result corresponding to the caller attestation information not including one or more required attestation features indicated by the authentication configuration information; and transmitting a message from the second device to the first device indicative of the one or more required attestation features not included in the caller attestation information corresponding to the unsuccessful authentication result.

### Aspect 91

The method of Aspect 90, further comprising: determining a successful secondary authentication result of the user of the first device, wherein the successful secondary authentication result is not based on the caller attestation information; and transmitting the message from the second device to the first device in response to the successful secondary authentication result.

### Aspect 92

An apparatus for communications, comprising: a memory; and a processor coupled to the memory, wherein the processor is configured to: obtain one or more inputs corresponding to a user of a first device, wherein the one or more inputs comprise sensor data obtained from one or more sensors of the first device; generate caller attestation information based on the sensor data of the one or more inputs, wherein the caller attestation information is indicative of one or more detected attestation features corresponding to the user of the first device and represented within the sensor data, and wherein the one or more detected attestation features are included in a configured plurality of attestation features; transmit, to a second device, a request to initiate a communication session between the first device and the second device, wherein the request includes the caller attestation information; and receive, from the second device and during the communication session, biometric information of a user of the second device, wherein the biometric information is received based on a successful authentication of the caller attestation information by the second device.

### Aspect 93

The apparatus of Aspect 92, wherein the one or more inputs include audio data obtained using the first device, the audio data indicative of biometric information corresponding to a voice of the user of the first device.

### Aspect 94

The apparatus of any of Aspects 92 to 93, wherein the one or more inputs include image data obtained using the first device, the image data indicative of biometric information corresponding to anatomy of the user of the first device.

### Aspect 95

The apparatus of any of Aspects 92 to 94, wherein the processor is further configured to: receive, from the second device and during the communication session, one or more obfuscated inputs, wherein the one or more obfuscated inputs do not include the biometric information of the user of the second device, and wherein the one or more obfuscated inputs are received based on an unsuccessful authentication of the caller attestation information by the second device.

### Aspect 96

The apparatus of Aspect 95, wherein the one or more obfuscated inputs are associated with a quality reduction codec of the second device.

### Aspect 97

The apparatus of Aspect 96, wherein the quality reduction codec is configured to reduce one or more of an original resolution associated with the one or more inputs, or an original sampling rate associated with the one or more inputs.

### Aspect 98

The apparatus of any of Aspects 96 to 97, wherein: the biometric information comprises image data of a face of the user of the second device; and the one or more obfuscated inputs are generated based on using the quality reduction codec to blur a portion of the image data corresponding to the face of the user of the second device, or to occlude the portion of the image data corresponding to the face of the user of the second device.

### Aspect 99

The apparatus of any of Aspects 96 to 98, wherein: the biometric information comprises audio data of a voice of the user of the second device; and the one or more obfuscated inputs are generated based on using the quality reduction codec to apply one or more audio distortions to the audio data.

### Aspect 100

The apparatus of any of Aspects 95 to 99, wherein: the biometric information comprises audiovisual data of the user of the second device, the audiovisual data obtained from one or more sensors of the second device and corresponding to the communication session; and the one or more obfuscated inputs comprise one or more degraded representations or masked representations of the audiovisual data with the biometric information removed.

### Aspect 101

The apparatus of any of Aspects 92 to 100, wherein the caller attestation information includes one or more attestation features generated by the first device.

### Aspect 102

The apparatus of Aspect 101, wherein the one or more attestation features are generated in association with the request to initiate the communication session.

### Aspect 103

The apparatus of any of Aspects 92 to 102, wherein the caller attestation information includes one or more attestation features obtained by the first device before the request to initiate the communication session.

### Aspect 104

The apparatus of any of Aspects 92 to 103, wherein the caller attestation information is determined by the first device based on information obtained from one or more sensors included in the first device.

### Aspect 105

The apparatus of Aspect 104, wherein the caller attestation information is determined by the first device without communication between the first device and one or more additional devices including the second device.

### Aspect 106

The apparatus of any of Aspects 92 to 105, wherein the caller attestation information includes one or more attestation features included in a configured plurality of attestation features.

### Aspect 107

The apparatus of any of Aspects 92 to 106, wherein the caller attestation information is indicative of one or more detected attestation features detected by the first device, the one or more detected attestation features included in a configured plurality of attestation features.

### Aspect 108

The apparatus of Aspect 107, wherein the caller attestation information is further indicative of one or more additional attestation features included in the configured plurality of attestation features and not detected by the first device.

### Aspect 109

The apparatus of any of Aspects 107 to 108, wherein each detected attestation feature of the one or more detected attestation features corresponds to one or more of a gesture performed by the user of the first device, a movement of the user of the first device, or a keyword spoken by the user of the first device.

### Aspect 110

The apparatus of any of Aspects 92 to 109, wherein the caller attestation information comprises an attestation bitmask including a plurality of attestation bits, and wherein a first value of a respective attestation bit of the plurality of attestation bits indicates a corresponding attestation feature was not detected for the user of the first device and a second value of the respective attestation bit indicates the corresponding attestation feature was detected for the user of the first device.

### Aspect 111

The apparatus of Aspect 110, wherein the attestation bitmask is based on sensor data obtained by the first device, the sensor data corresponding to the user of the first device.

### Aspect 112

The apparatus of any of Aspects 110 to 111, wherein determining the authentication result comprises comparing the attestation bitmask to the authentication configuration information associated with the user of the second device.

### Aspect 113

The apparatus of Aspect 112, wherein: the authentication configuration information is indicative of one or more required attestation features; and a successful authentication result is determined based on the attestation bitmask including a corresponding attestation bit equal to the second value for each of the one or more required attestation features.

### Aspect 114

The apparatus of Aspect 113, wherein: the authentication configuration information is indicative of a threshold number of attestation features; and a successful authentication result is determined based on the attestation bitmask including a quantity of respective attestation bits equal to the second value that is greater than or equal to the threshold number.

### Aspect 115

The apparatus of any of Aspects 112 to 114, wherein the processor is further configured to: determine an unsuccessful authentication result based on the attestation bitmask including a number of respective attestation bits with the second value that is less than a threshold indicated by the authentication configuration information; or determine the unsuccessful authentication result based on the attestation bitmask including the first value for a respective attestation bit corresponding to a required attestation feature indicated by the authentication configuration information.

### Aspect 116

The apparatus of any of Aspects 92 to 115, wherein the authentication configuration information comprises one or more authentication requirements associated with the user of the second device.

### Aspect 117

The apparatus of any of Aspects 92 to 116, wherein the authentication configuration information comprises one or more authentication criteria to determine a corresponding authentication result for a received caller attestation information.

### Aspect 118

The apparatus of any of Aspects 92 to 117, wherein the authentication configuration information is indicative of one or more authentication requirements to determine a successful authentication result for a received caller attestation information.

### Aspect 119

The apparatus of any of Aspects 92 to 118, wherein the processor is further configured to: determine an unsuccessful authentication result corresponding to the caller attestation information not including one or more required attestation features indicated by the authentication configuration information; and transmit a message from the second device to the first device indicative of the one or more required attestation features not included in the caller attestation information corresponding to the unsuccessful authentication result.

### Aspect 120

The apparatus of Aspect 119, wherein the processor is further configured to: determine a successful secondary authentication result of the user of the first device, wherein the successful secondary authentication result is not based on the caller attestation information; and transmit the message from the second device to the first device in response to the successful secondary authentication result.

### Aspect 121

A method for wireless communications, comprising performing operations according to any of Aspects 32 to 62.

### Aspect 122

A method for wireless communications, comprising performing operations according to any of Aspects 92 to 120.

### Aspect 123

A non-transitory computer-readable storage medium comprising instructions stored thereon which, when executed by at least one processor, causes the at least one processor to perform operations according to any of Aspects 1 to 31 or 32 to 62.

### Aspect 124

A non-transitory computer-readable storage medium comprising instructions stored thereon which, when executed by at least one processor, causes the at least one processor to perform operations according to any of Aspects 63 to 91 or 92 to 120.

### Aspect 125

An apparatus for wireless communication comprising one or more means for performing operations according to any of Aspects 1 to 31 or 32 to 62.

### Aspect 126

An apparatus for wireless communication comprising one or more means for performing operations according to any of Aspects 63 to 91 or 92 to 120.

What is claimed is:

1. A method for communications by a first device, the method comprising:
receiving, from a second device, a request to initiate a communication session between the second device and the first device wherein the request includes caller attestation information corresponding to a user of the second device, the caller attestation information determined by the second device based on information obtained from one or more sensors included in the second device;
determining an authentication result corresponding to the request to initiate the communication session, the authentication result determined based on comparing the caller attestation information included in the request with authentication configuration information associated with a user of the first device; and
configuring the communication session between the second device and the first device based on the authentication result, wherein configuring the communication session includes processing one or more inputs corresponding to biometric information of the user of the first device based on the authentication result.

2. The method of claim 1, wherein the one or more inputs include one or more of:
audio data obtained using the first device, the audio data indicative of biometric information corresponding to a voice of the user of the first device, or image data obtained using the first device, the image data indicative of biometric information corresponding to anatomy of the user of the first device.

3. The method of claim 1, wherein configuring the communication session based on a successful authentication result includes:
obtaining the one or more inputs corresponding to biometric information of the user of the first device by one or more input devices of the first device; and
transmitting the one or more inputs to the second device during the communication session, wherein the communication session includes the biometric information of the user of the first device.

4. The method of claim 1, wherein configuring the communication session based on an unsuccessful authentication result includes:
obtaining the one or more inputs corresponding to biometric information of the user of the first device by one or more input devices of the first device;
processing the one or more inputs to generate one or more obfuscated inputs, wherein the one or more obfuscated inputs do not include the biometric information of the user of the first device; and
transmitting the one or more obfuscated inputs to the second device during the communication session, wherein the communication session does not include the biometric information of the user of the first device.

5. The method of claim 4, further comprising generating the one or more obfuscated inputs based on processing the one or more inputs using a quality reduction codec.

6. The method of claim 5, wherein:
the one or more inputs corresponding to the biometric information are associated with a first quality level; and
the one or more obfuscated inputs are associated with a second quality level, the second quality level less than the first quality level.

7. The method of claim 5, wherein the quality reduction codec is configured to reduce one or more of an original resolution associated with the one or more inputs, or an original sampling rate associated with the one or more inputs.

8. The method of claim 5, wherein:
the one or more inputs corresponding to the biometric information comprise image data of a face of the user of the first device; and
processing the one or more inputs using the quality reduction codec corresponds to one or more of blurring a portion of the image data corresponding to the face of the user of the first device, or occluding the portion of the image data corresponding to the face of the user of the first device.

9. The method of claim 5, wherein:
the one or more inputs corresponding to the biometric information comprise audio data of a voice of the user of the first device; and
processing the one or more inputs using the quality reduction codec corresponds to applying one or more audio distortions to the audio data.

10. The method of claim 4, wherein:
the one or more inputs comprise audiovisual data of the user of the first device, the audiovisual data obtained from one or more sensors of the first device and corresponding to the communication session; and
the one or more obfuscated inputs comprise one or more degraded representations or masked representations of the audiovisual data with the biometric information removed.

11. The method of claim 1, wherein the caller attestation information includes one or more attestation features generated by the second device.

12. The method of claim 11, wherein the one or more attestation features are generated in association with the request to initiate the communication session.

13. The method of claim 1, wherein the caller attestation information is determined based on one or more attestation features obtained by the second device before the request to initiate the communication session.

14. The method of claim 1, wherein the caller attestation information is determined by the second device based on one or more biometric inputs corresponding to the user of the second device, the one or more biometric inputs corresponding to the user of the second device included in the information obtained from the one or more sensors included in the second device.

15. The method of claim 1, wherein the caller attestation information is determined by the second device without communication between the second device and one or more additional devices different from the first device.

16. The method of claim 1, wherein the caller attestation information includes one or more attestation features included in a configured plurality of attestation features.

17. The method of claim 1, wherein the caller attestation information is indicative of one or more detected attestation features detected by the second device, the one or more detected attestation features included in a configured plurality of attestation features.

18. The method of claim 17, wherein the caller attestation information is further indicative of one or more additional attestation features included in the configured plurality of attestation features and not detected by the second device.

19. The method of claim 17, wherein each detected attestation feature of the one or more detected attestation features corresponds to one or more of a gesture performed by the user of the second device, a movement of the user of the second device, or a keyword spoken by the user of the second device.

20. The method of claim 1, wherein the caller attestation information comprises an attestation bitmask including a plurality of attestation bits, and wherein a first value of a respective attestation bit of the plurality of attestation bits indicates a corresponding attestation feature was not detected for the user of the second device and a second value of the respective attestation bit indicates the corresponding attestation feature was detected for the user of the second device.

21. The method of claim 20, wherein the attestation bitmask is based on sensor data obtained by the second device, the sensor data corresponding to the user of the second device.

22. The method of claim 20, wherein determining the authentication result comprises comparing the attestation bitmask to the authentication configuration information associated with the user of the first device.

23. The method of claim 22, wherein:
the authentication configuration information is indicative of one or more required attestation features; and
a successful authentication result is determined based on the attestation bitmask including a corresponding attestation bit equal to the second value for each of the one or more required attestation features.

24. The method of claim 23, wherein:
the authentication configuration information is indicative of a threshold number of attestation features; and
a successful authentication result is determined based on the attestation bitmask including a quantity of respective attestation bits equal to the second value that is greater than or equal to the threshold number.

25. The method of claim 22, further comprising:
determining an unsuccessful authentication result based on the attestation bitmask including a number of respective attestation bits with the second value that is less than a threshold indicated by the authentication configuration information; or
determining the unsuccessful authentication result based on the attestation bitmask including the first value for a respective attestation bit corresponding to a required attestation feature indicated by the authentication configuration information.

26. The method of claim 1, wherein the authentication configuration information includes one or more of: one or more authentication requirements associated with the user of the first device, or one or more authentication criteria to determine a corresponding authentication result for a received caller attestation information.

27. The method of claim 1, further comprising:
determining an unsuccessful authentication result corresponding to the caller attestation information not including one or more required attestation features indicated by the authentication configuration information; and
transmitting a message from the first device to the second device indicative of the one or more required attestation features not included in the caller attestation information corresponding to the unsuccessful authentication result.

28. The method of claim 27, further comprising:
determining a successful secondary authentication result of the user of the second device, wherein the successful secondary authentication result is not based on the caller attestation information; and
transmitting the message from the first device to the second device in response to the successful secondary authentication result.

29. An apparatus of a first device for communications, comprising:
a memory; and
a processor coupled to the memory, wherein the processor is configured to:
receive, from a second device, a request to initiate a communication session between the second device and the first device wherein the request includes caller attestation information corresponding to a user of the second device, the caller attestation information determined by the second device based on information obtained from one or more sensors included in the second device;
determine an authentication result corresponding to the request to initiate the communication session, the authentication result determined based on comparing the caller attestation information included in the request with authentication configuration information associated with a user of the first device; and
configure the communication session between the second device and the first device based on the authentication result, wherein configuring the communication session includes processing one or more inputs corresponding to biometric information of the user of the first device based on the authentication result.

30. An apparatus for communications, comprising:
a memory; and
a processor coupled to the memory, wherein the processor is configured to:
obtain one or more inputs corresponding to a user of a first device, wherein the one or more inputs comprise sensor data obtained from one or more sensors of the first device;
generate caller attestation information based on the sensor data of the one or more inputs, wherein the caller attestation information is indicative of one or more detected attestation features corresponding to the user of the first device and represented within the sensor data, and wherein the one or more detected attestation features are included in a configured plurality of attestation features;
transmit, to a second device, a request to initiate a communication session between the first device and the second device, wherein the request includes the caller attestation information; and
receive, from the second device and during the communication session, biometric information of a user of the second device, wherein the biometric information is received based on a successful authentication of the caller attestation information by the second device.
